(19) United States
(12) Patent Application Publication
(10) Pub. No.: US 2017/0193592 A1
(43) Pub. Date: Jul. 6, 2017

(54) METHOD, SYSTEM, AND COMPUTER-READABLE STORAGE MEDIUM FOR FACILITATING RECURRING ORDERING, BILLING, AND INVENTORY UPDATING

(71) Applicant: Rhino Saas IP Holding Co, LLC, Dunwoody, GA (US)

(72) Inventors: Sneer AVIDAN, Norcross, GA (US); Tamir COHEN, Tel Katzir (IL); Yael SHOHAM, Tel Katzir (IL); Juan Martin ETCHECHOURY, Dunwoody, GA (US); Martin SZNAPER, CABA (Buenos Aires) (AR)

(73) Assignee: Rhino Saas IP Holding Co, LLC, Dunwoody, GA (US)

(21) Appl. No.: 15/399,314

(22) Filed: Jan. 5, 2017

Related U.S. Application Data
(60) Provisional application No. 62/275,005, filed on Jan. 5, 2016.

(51) Int. Cl. G06Q 30/06; G06Q 30/04; G06Q 10/08

(52) U.S. Cl. CPC G06Q 30/0635; G06Q 10/087; G06Q 30/04

(57) ABSTRACT

Generally described, the present invention relates to a recurring billing/ordering application that works with an ecommerce platform to enable a merchant to sell products on a recurring basis. The recurrence application enables the merchant to create subscriptions for recurrence frequency sets and assigned products, creates recurrence rule/option sets corresponding to the frequency sets for the assigned products, collects from the ecommerce platform its assigned rule-set IDs for the frequency set, and saves the IDs and the corresponding frequency set in a database. Then upon receiving a customer order for a product with a recurrence frequency selected from a frequency set, the recurrence application collects rule-set IDs from the ecommerce platform, checks the database for any of those IDs, and upon finding a match uses the corresponding frequency for processing the recurring orders, without having to be redirected from the ecommerce platform to an external account to obtain this information.

### CROSS-REFERENCE TO RELATED APPLICATION

This application claims the priority benefit of U.S. Provisional Patent Application Ser. No. 62/275,005, filed Jan. 5, 2016, which is hereby incorporated herein by reference.

### TECHNICAL FIELD

The present invention relates generally to ordering of and billing for goods and services, and particularly to online recurring ordering, billing, and inventory updating.

### BACKGROUND

On-line stores have become popular for users due to their convenience. By visiting a store's ecommerce website, a customer is able to view goods/services, order desired goods/services, pay for the goods/services, and have them delivered. Most store websites allow for selecting from a variety of different options (e.g., colors, sizes, flavors, styles, etc.) when purchasing products. In addition, some store websites allow customers to set up recurring orders such that a goods/service is charged for and delivered automatically on a regular basis (e.g., monthly or weekly).

While on-line stores are popular, convenient, and often offer many options for ordering products, they have their drawbacks. For example, many merchants do not custom-build from scratch their own online commerce website for selling their goods and services, instead they use existing ecommerce platforms that provide the needed customizable storefront functionality. Examples of such ecommerce platforms include those provided by Bigcommerce, Inc. (the BIGCOMMERCE platform available at bigcommerce.com), Shopify Inc. (the SHOPIFY platform available at shopify.com), and X.commerce, Inc. (the MAGENTO platform available at magento.com). But ordering and billing recurring orders can be cumbersome for merchants to handle using these conventional ecommerce platforms.

In addition, billing and inventory for online stores are typically handled separately for recurring orders. That is, when a customer places a recurring order, a bill is generated for each recurrence when the product is shipped. The merchant must adjust the inventory and then also separately account for each bill generated when the ordered product is shipped for each recurrence. This results in a cumbersome accounting/inventory control process for the merchant.

Accordingly, it can be seen that needs exist for improvements in online ordering, billing, and inventory updating for recurring orders. It is to the provision of solutions to these and other problems that the present invention is primarily directed.

### SUMMARY

Generally described, the present invention relates to a recurring billing/ordering software application on a computer-readable storage medium of an ecommerce server that works with an ecommerce platform to provide an interface for a merchant to offer and process goods and/or services for sale on a recurring basis. The recurrence application enables the merchant to create subscriptions each for a selected recurrence frequency set (of available/optional recurrence frequencies) and selected assigned products (for which customers will be able to choose from the recurrence frequency set), creates a recurrence rule/option set (in the ecommerce platform application) including the same recurrence frequency set for each of the assigned products, collects from the ecommerce platform its assigned rule/option-set IDs for the recurrence frequency set, and saves the rule/option-set IDs and the corresponding recurrence frequency set in a database. Then upon receiving a customer order for a product with a recurrence frequency selected from the corresponding frequency set, the recurrence application collects rule/option-set IDs in a response from the ecommerce platform, looks in the database for any of those IDs, and upon finding a match uses the corresponding frequency of the corresponding frequency set (and payment information captured at checkout of the original order) for initiating the recurring orders in the ecommerce platform. In this way, the recurrence application determines, from the ecommerce platform checkout page, the recurrence frequency and the product of a recurring order, without having to be redirected to an external (outside of the recurrence app and the ecommerce platform) account or billing/ordering mechanism.

The specific techniques and structures employed to improve over the drawbacks of the prior systems and methods, and to accomplish the advantages described herein, will become apparent from the following detailed description of example embodiments and the appended drawings and claims.

### BRIEF DESCRIPTION OF THE DRAWINGS

FIG. 1 illustrates a system including an ecommerce server providing a customizable rule set of options to a merchant computer according to an example embodiment.

FIG. 2 illustrates an example of a screen showing order, billing, and inventory status to a merchant computer according to an example embodiment.

FIG. 3 illustrates an example of a screen which may be used for selecting a product for option editing by the merchant computer according to an example embodiment.

FIGS. 4A-4E illustrate examples of screens which may be used to edit options for a product to include options for recurring ordering/billing and to present such options to a customer computer according to an example embodiment.

FIGS. 5A-5E illustrate examples of screens which may be used to edit options for a product to include options for different quantities and options for recurring ordering/billing and to present such options to a customer computer according to an example embodiment.

FIGS. 6A-6L illustrate examples of screens which may be used to edit options for a product to include only selected periods for recurring ordering/billing and to present such options to a customer computer according to an example embodiment.

FIGS. 7A-7D illustrate examples of screens which may be used to edit options for a product such that a message is displayed to a customer if a recurring order period is selected which is not a valid recurring order period as set by the merchant according to an example embodiment.

FIG. 8 is a flow diagram showing a recurring ordering/billing method according to an example embodiment.

FIG. 9 is flow diagram showing two methods of creating rule/options sets of recurrence frequencies for recurring orders according to an example embodiment.

FIG. 10 is a flow diagram showing a method of initiating a subsequent/recurrence order for a product that was purchased on a recurring basis in a previous order according to an example embodiment.

FIGS. 11-16 illustrate examples of screens which may be used to implement the recurrence set-up process of FIGS. 8-9 according to an example embodiment.

FIGS. 17-19 illustrate examples of screens which may be used to implement the recurring order process of FIGS. 8 and 10 according to an example embodiment.

### DETAILED DESCRIPTION OF EXAMPLE EMBODIMENTS

The present invention relates to a recurring ordering/billing software application that is made available (e.g., by an ecommerce server) to a merchant computer at the same URL as the merchant's ecommerce storefront (e.g., from an ecommerce platform) that is hosted by the ecommerce server. The application seamlessly interfaces with the API of the ecommerce platform, such as the BIGCOMMERCE platform, the SHOPIFY platform, or the MAGENTO platform, to provide for ease of use by the merchant. This allows the merchant to process recurring orders without requiring redirection to an external/third-party account.

As used herein, the term “merchant” is intended to be broadly construed to mean any type of seller, dealer, retailer, distributor, or store owner or operator, including a non-profit organization. The term “product” is intended to be broadly construed to mean any type of good and/or service. The term “application” is intended to be broadly construed to mean any type of software product, whether delivered by download, storage device, or otherwise, whether an integrally provided component of the ecommerce platform or separately provided for integration and use therewith, and/or whether stored remotely and accessed over a communications network or stored locally. The term “recurring ordering/billing application” (aka the recurrence application) is intended to be broadly construed to mean an application providing the essential functionality, but not necessarily all of the functionally, described and claimed herein. It will be appreciated that example embodiments of the recurring ordering/billing application may be sometimes referenced herein as the REBILLIA app, however that reference is intended as representative and not limiting of the invention. And the term “ecommerce platform” is intended to be broadly construed to mean any type of software technology solution that (a) provides merchant-facing backends that enable merchants to customize and manage customer-facing storefronts on their websites for selling their products to their customers and (b) has an API or other interface for working with the recurrence application as described herein (as such, the terms “application” and “platform” are used interchangeably herein with respect to the ecommerce software, and any distinction between these terms is not considered important to a ful understanding of the invention). It will be appreciated that although example embodiments are shown and described in conjunction with the BIGCOMMERCE platform, the recurrence application can be implemented for use with other ecommerce platforms.

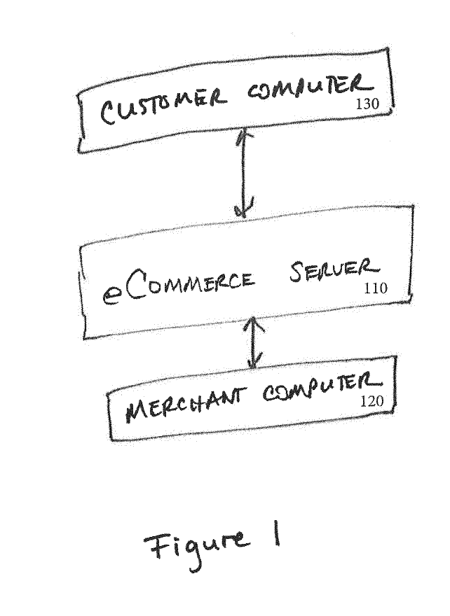

FIG. 1 shows an ecommerce system 100 according to according to a first example embodiment of the invention. The ecommerce system 100 includes an ecommerce server 110 that stores an ecommerce platform application and a recurring billing/ordering application (the recurrence application) and that communicates with a merchant computer 120 and a customer computer 130. The ecommerce server 110 can communicate with the merchant computer 120 and the customer computer 130 via any suitable connection such as the Internet or another communications network.

Further, although one merchant computer 120 and one customer computer 130 are shown for ease of illustration, it should be appreciated that any number of merchant computers and/or customer computers can be served by the ecommerce server 110 in the manner described herein. Similarly, although one ecommerce server 110 is shown for ease of illustration, it should be appreciated that any number of them can be included in the ecommerce system 100, for example in cloud-based and/or server-farm systems, or where the ecommerce platform and the application are located on separate but still connected/accessible servers (for example the recurrence application can call the ecommerce platform's API using the HTTP protocol).

Although not illustrated, it should be appreciated that the ecommerce server 110, the merchant computer 120, and the customer computer 130 each include conventional components, such as a processor and a memory medium storing computer-readable instructions that are executable by the processor to perform various operations including those described herein. The computer-readable instructions can be stored on non-transitory computer-readable storage media of a conventional type, whether devices and/or materials.

For example, the ecommerce server(s) 110 can include applications stored in its memory storage medium. Such applications can provide for receiving, processing, and reconciling orders, billing, and inventory, and presenting such information to the merchant computer 120. For example, such applications can include the ecommerce platform for hosting an ecommerce storefront for the merchant computer 120 and making the estorefront interface accessible to the customer computer 130. And such applications can include the recurrence application that provides an interface to the merchant computer 120 to customize rule sets for offering products for sale to the customer computer 130.

The ecommerce platform application provides an interface allowing the merchant computer 120 to customize rule sets for offering products for sale to the customer computer 130, and accepting orders for such products. For example, the customizable rule sets allow the merchant computer to select options such as size, quantity, and color, then to select options sets such as small, medium, and large (for size options), such as 1, 2, and 4 (for quantity options), and such as red, blue, and green (for color options).

The recurrence application provides an interface allowing the merchant computer 120 to customize rule sets for offering products for sale to the customer computer 130 on a recurring basis using the rule/option sets of the ecommerce platform. For example, the customizable rule/option sets can be used to enable the merchant computer to select recurrence frequency set options for recurring orders such as the recurrence period units (e.g., daily, weekly, monthly, or yearly) and the recurrence period values (e.g., 1, 2, 3, 4, 5, 6, 7, 8, 9, 10, 11, or 12).

Upon creating one of those rule/option sets, the recurrence application receives a response from the ecommerce platform (e.g., via its API) with IDs for each datum of the created rule/option set. In the example set forth immediately above, there are 4 period units and 12 period values for a total of 16 IDs. The merchant then uses the merchant computer to manually add those IDs to the existing option set(s) (size, quantity, color, etc.) for the product in the ecommerce platform. When a customer makes a selection of 2 of those 16 datum (e.g., “weeks” and “3”), the recurrence application receives the corresponding IDs (e.g., “weeks”=“777” and “3”=“a7b3”) in the ecommerce platform's checkout process, through its API, and translates those IDs to the actual recurrence frequency (e.g., 777+a7b3=every 21 days to the recurrence application (e.g., its database). In alternative embodiments, the recurrence application creates the recurring frequency (e.g., Option and Option Set) automatically and from only from piece of data (instead of two) to simplify the process for the merchant user.

In this way, the merchant can decide which products it wants to allow customers to choose to order on a recurring basis and can also choose the recurrence frequencies (intervals) that may be provided as options to customers, without requiring the use of an external billing/ordering mechanism.

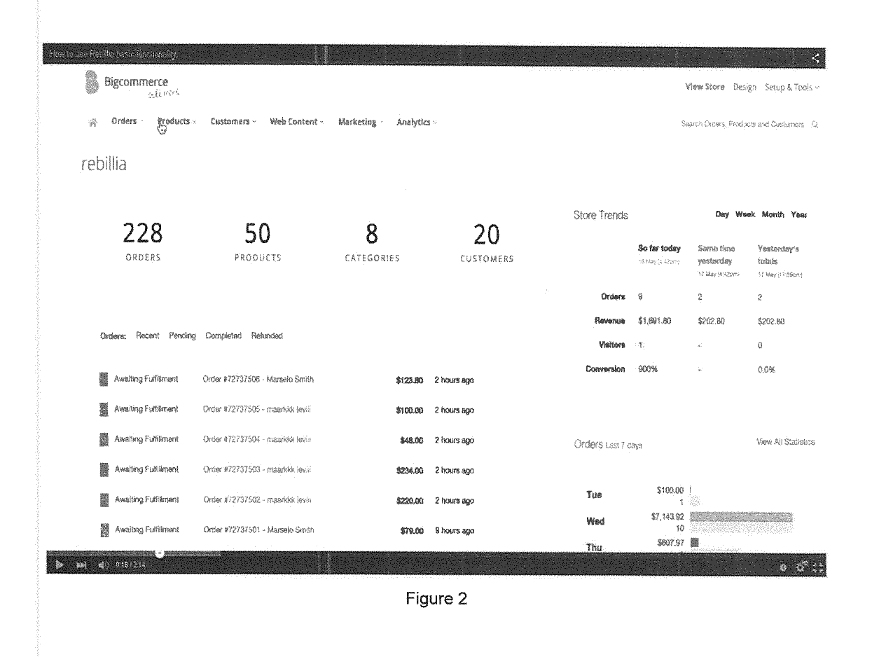

FIGS. 2-7D are example screen shots that illustrate merchant-facing and customer-facing interfaces for implementing the functionality described herein. These screen shots are representative for illustrating various aspects relating to the first example embodiment, and as such are not intended to be unnecessarily limiting of the invention as claimed herein. As such, the layout, headings, conventional design and functionality, etc. depicted in these screen shots can be modified without departing from the scope of the invention.

FIG. 2 illustrates an example of a screen showing order, billing, and inventory status to a merchant computer. As can be seen from FIG. 2, the screen may show current orders, product inventory, categories, and customers. Using this screen displayed to the merchant computer 120, the merchant can keep track of inventory and billing, by using the ecommerce application and the recurrence application, without relying on a third party for those tasks.

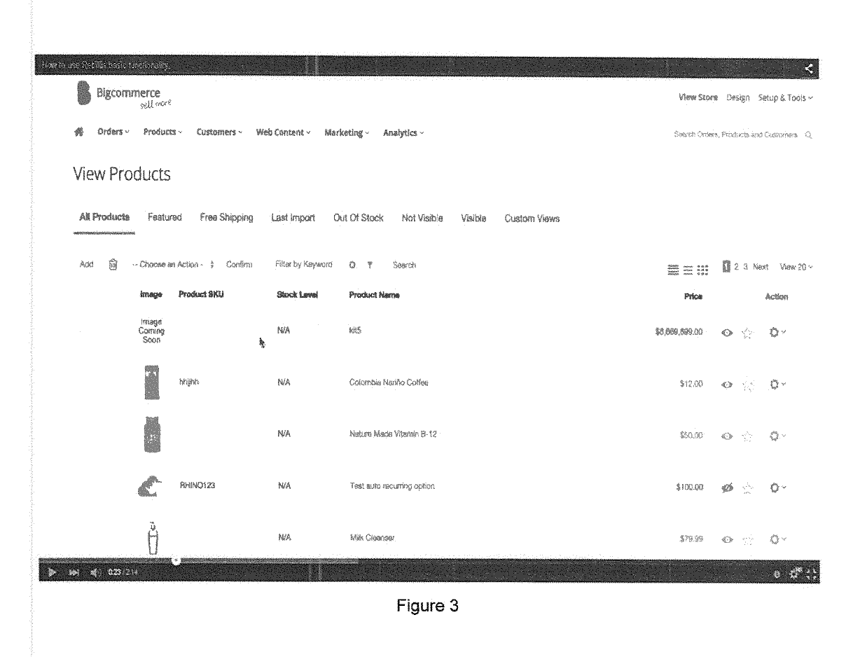

FIG. 3 illustrates an example of a screen which may be used for selecting a product for option editing. Using this screen displayed to the merchant computer 120, the merchant selects a product which causes another screen to be presented for editing the options available for ordering the product.

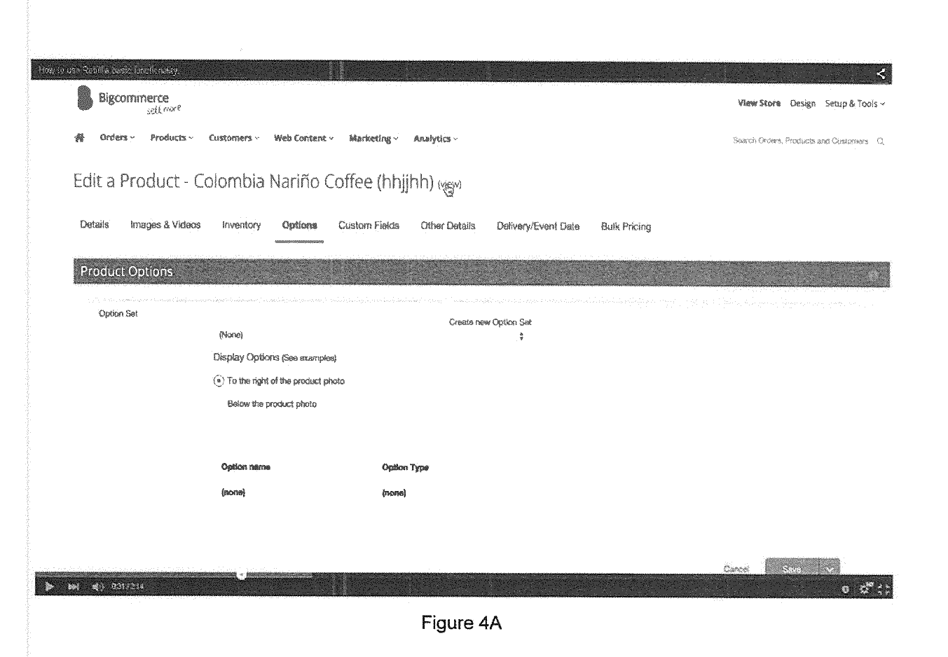

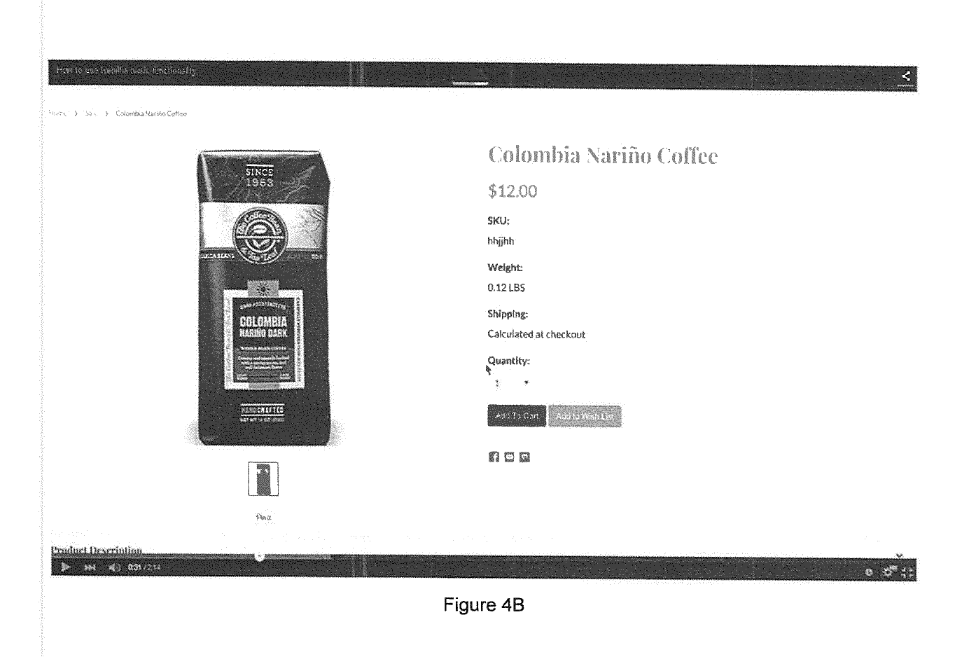

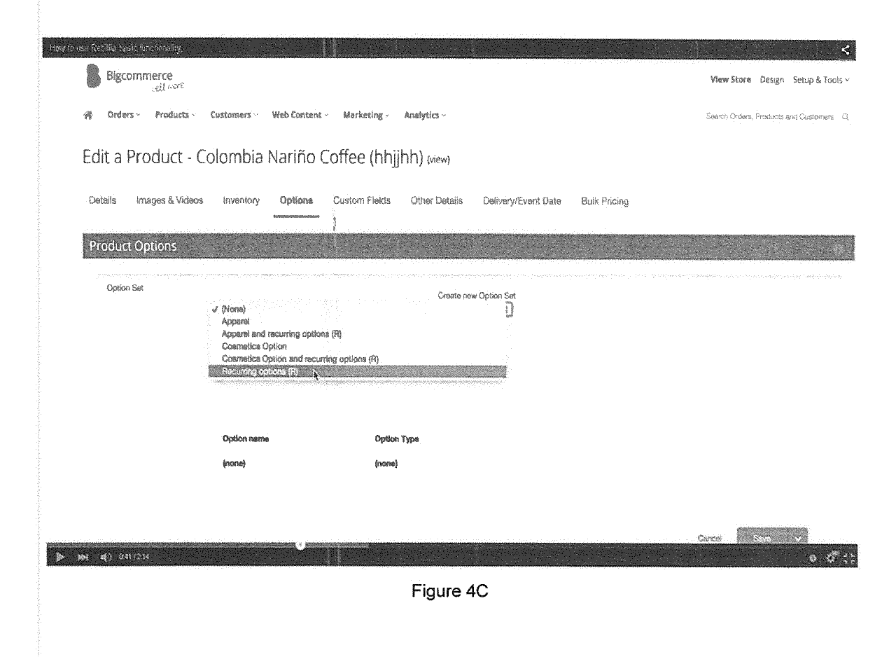

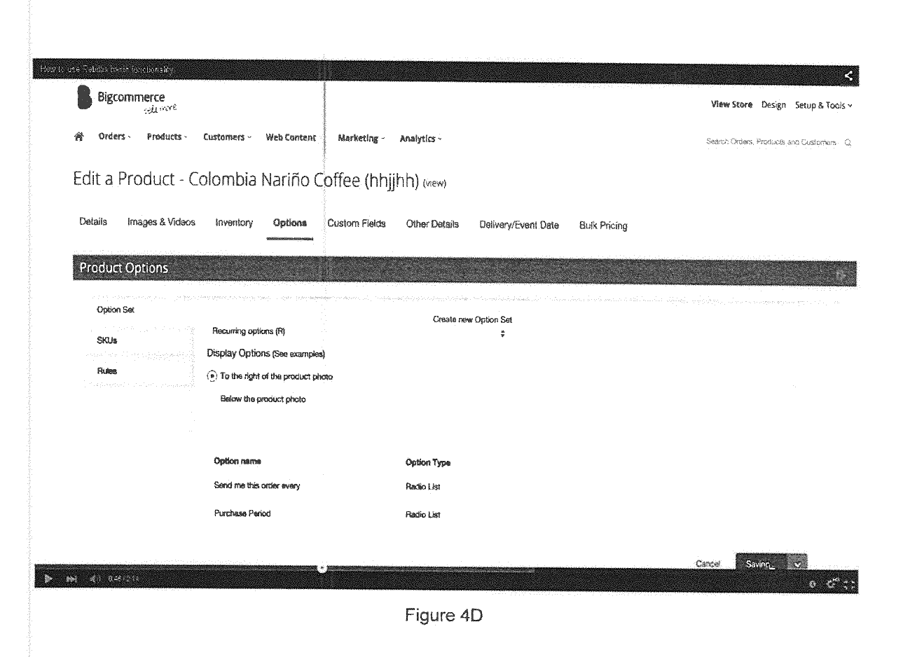

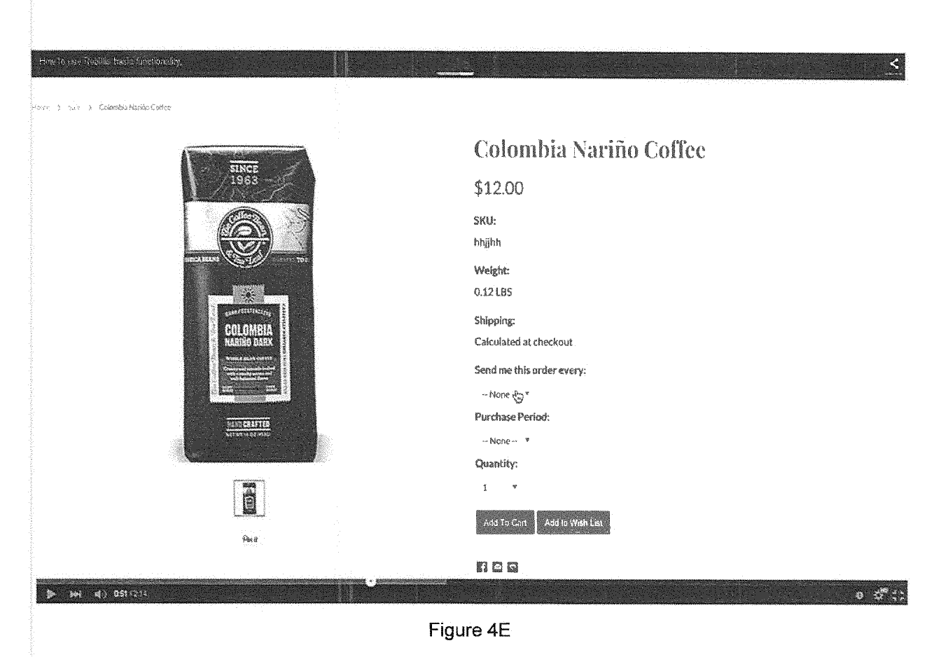

FIGS. 4A-4E illustrate examples of screens which may be used to edit options for a product to include options for recurring ordering and to present such options to a customer. Referring to FIG. 4A, a screen presented to a merchant via the merchant computer indicates that a coffee product offered by the merchant has been selected for editing. FIG. 4B illustrates an unedited screen presented to the customer via the customer computer for ordering the coffee. FIG. 4C illustrates a screen used by the merchant to select an option for offering recurring ordering/billing for the coffee. FIG. 4D illustrates a screen that shows that recurring ordering has been selected by the merchant. And FIG. 4E illustrates an updated screen presented to the customer that shows options for selecting recurring orders.

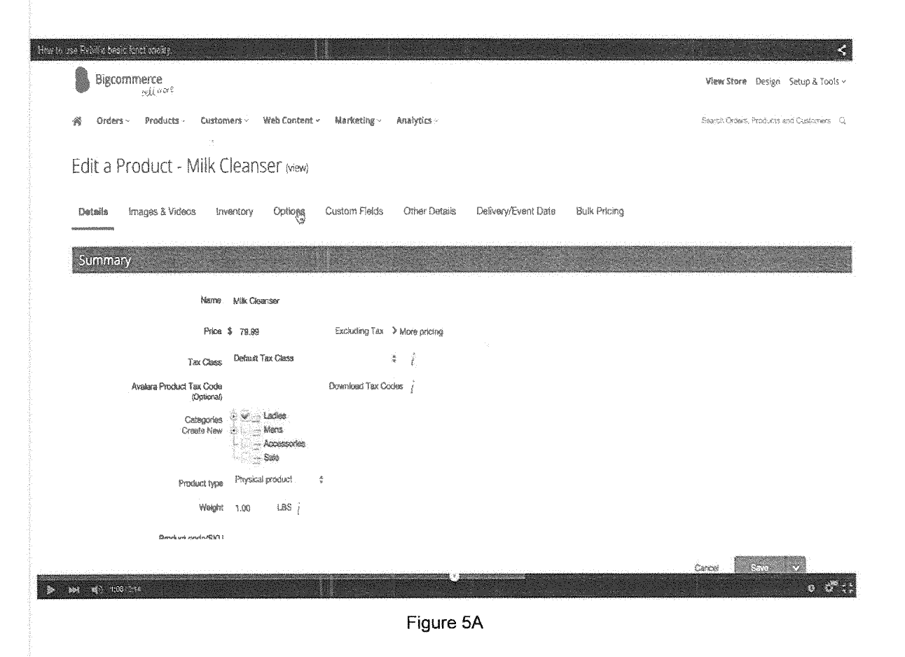

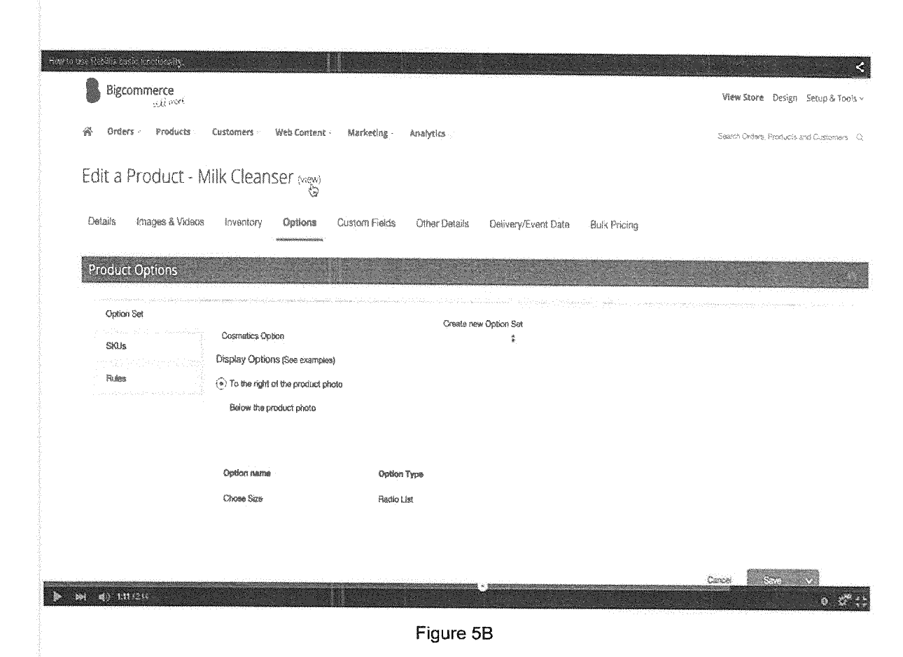

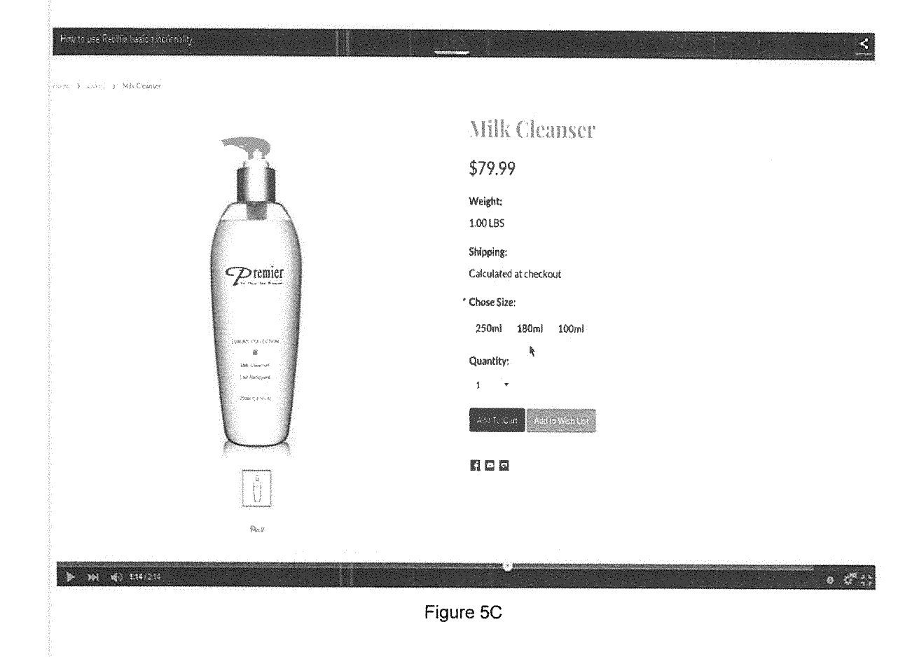

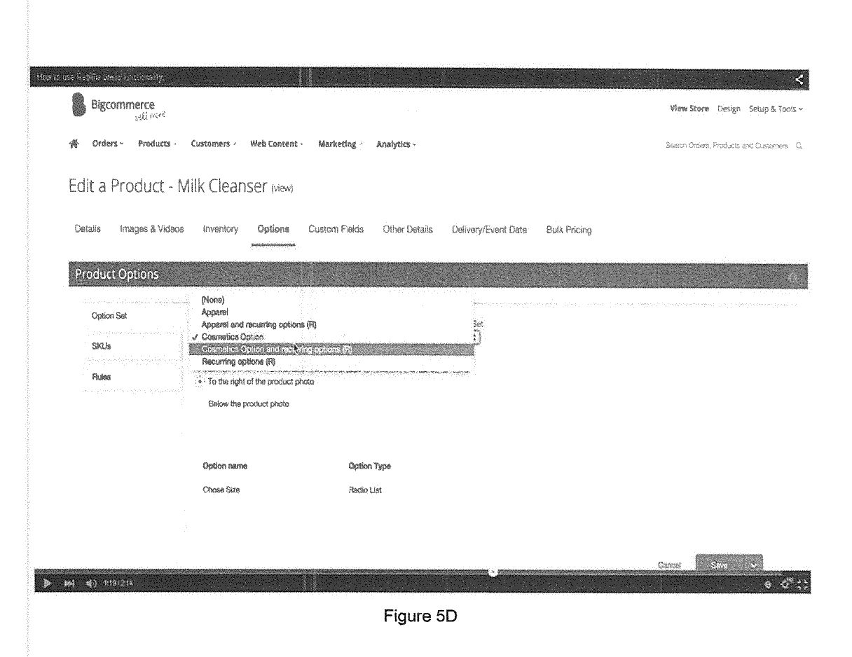

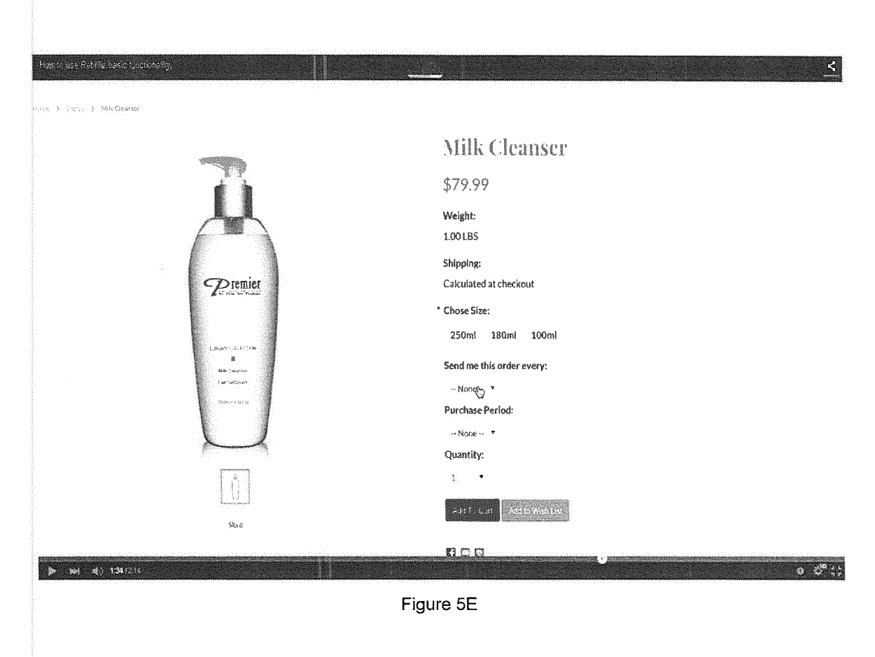

FIGS. 5A-5E illustrate examples of screens which may be used to edit options for a product to include options for different quantities and options for recurring ordering/billing and to present such options to a customer. Referring to FIG. 5A, a screen presented to a merchant indicates that a ladies milk cleanser product offered by the merchant has been selected for editing. FIG. 5B is a screen that shows that the merchant has selected an option for offering different sizes of the cleanser product. FIG. 5C illustrates a screen presented to the customer that shows the different sizes offered for ordering the product. FIG. 5D illustrates a screen used by the merchant for selecting a recurring order option for the cleanser product. And FIG. 5E illustrates an updated screen presented to the customer that shows options for sizes, quantities, and recurring orders.

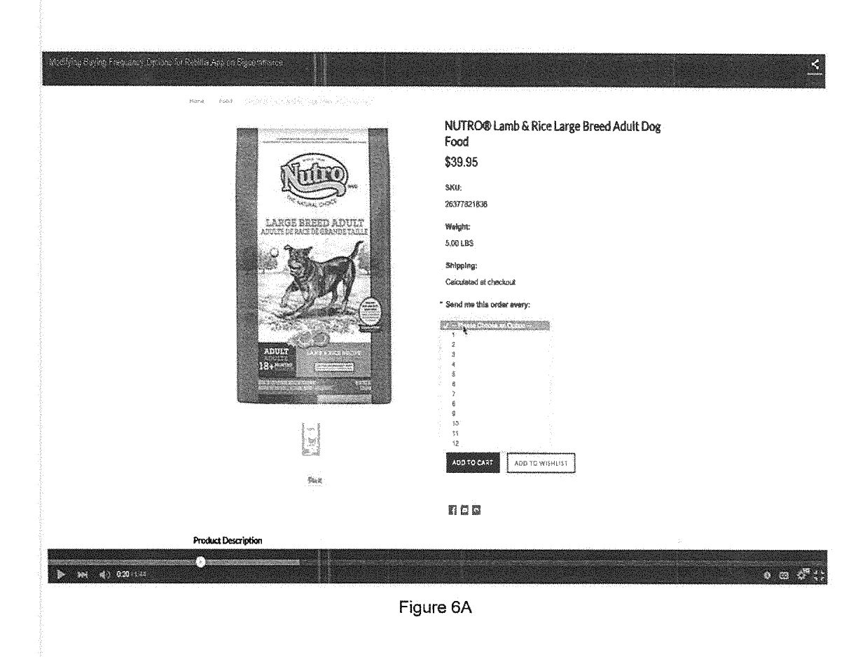

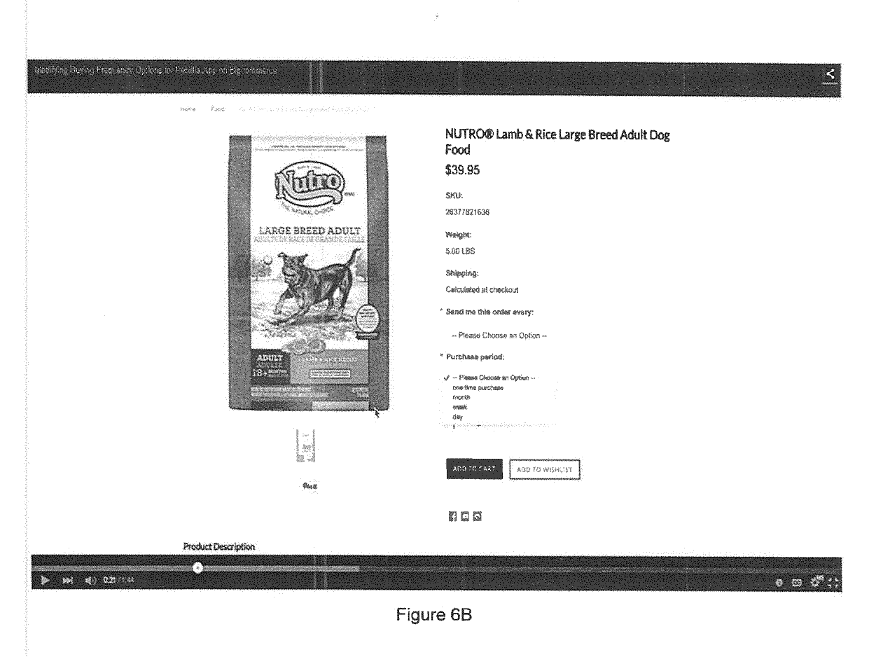

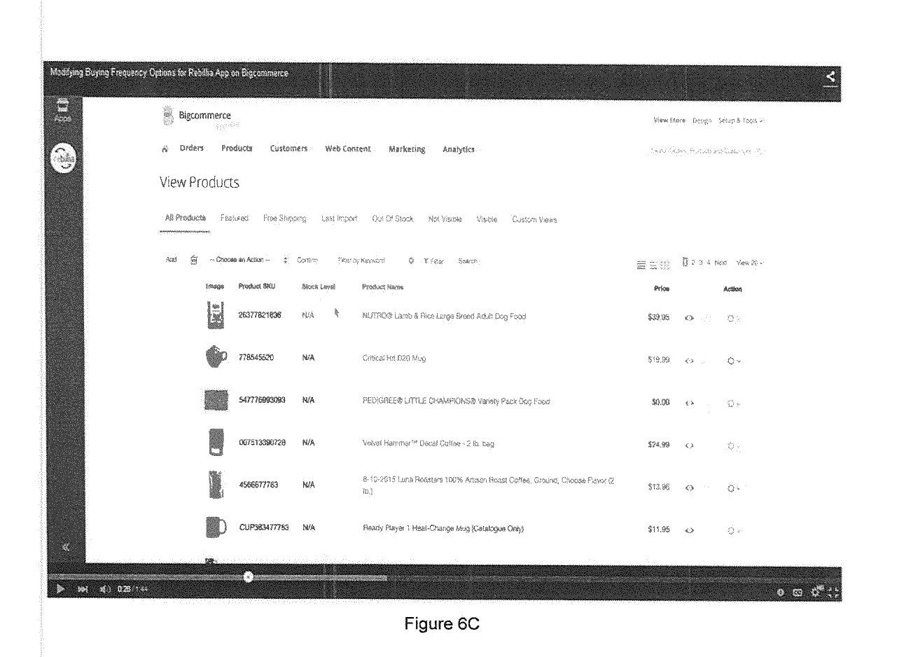

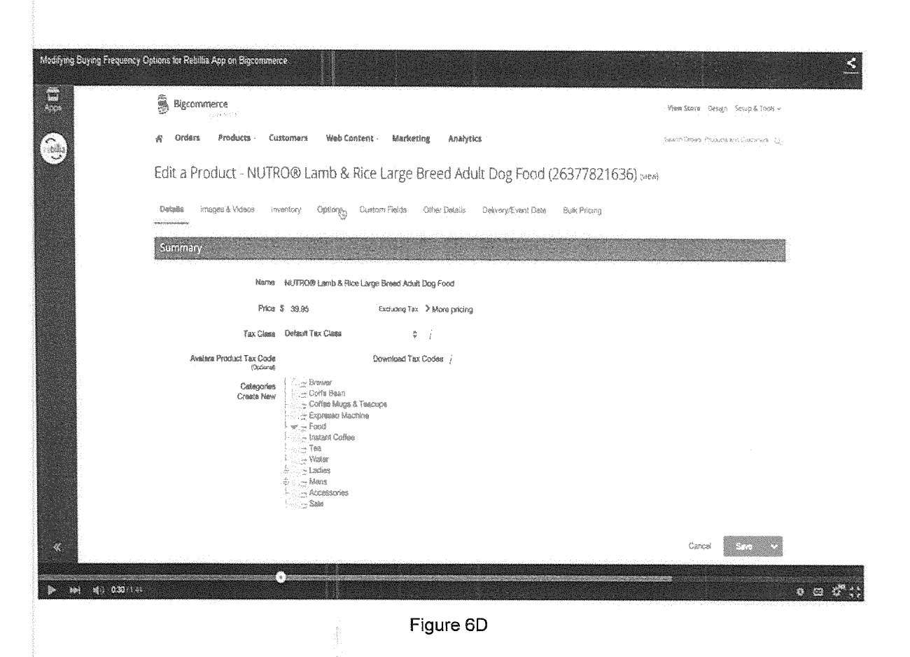

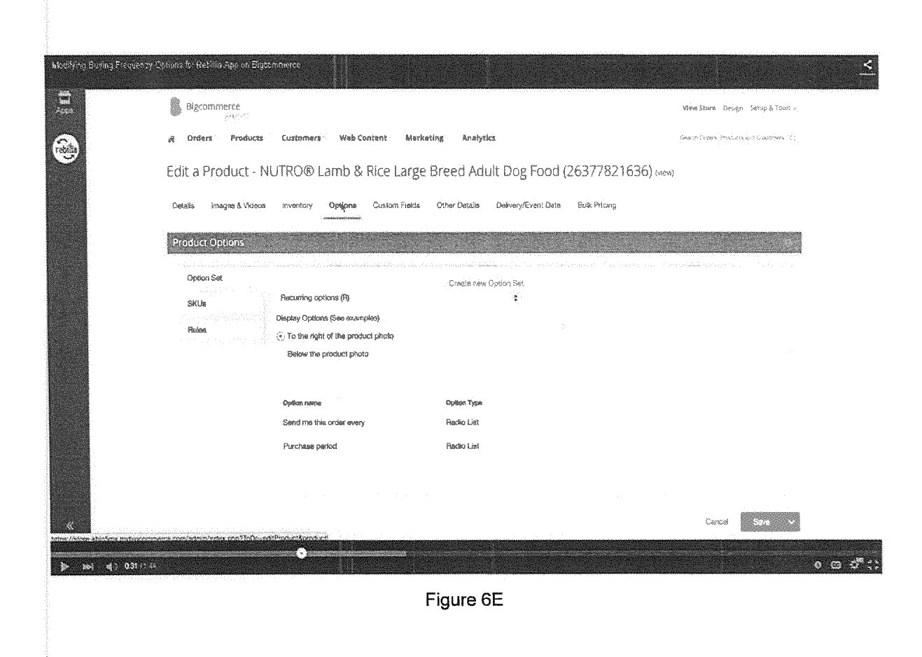

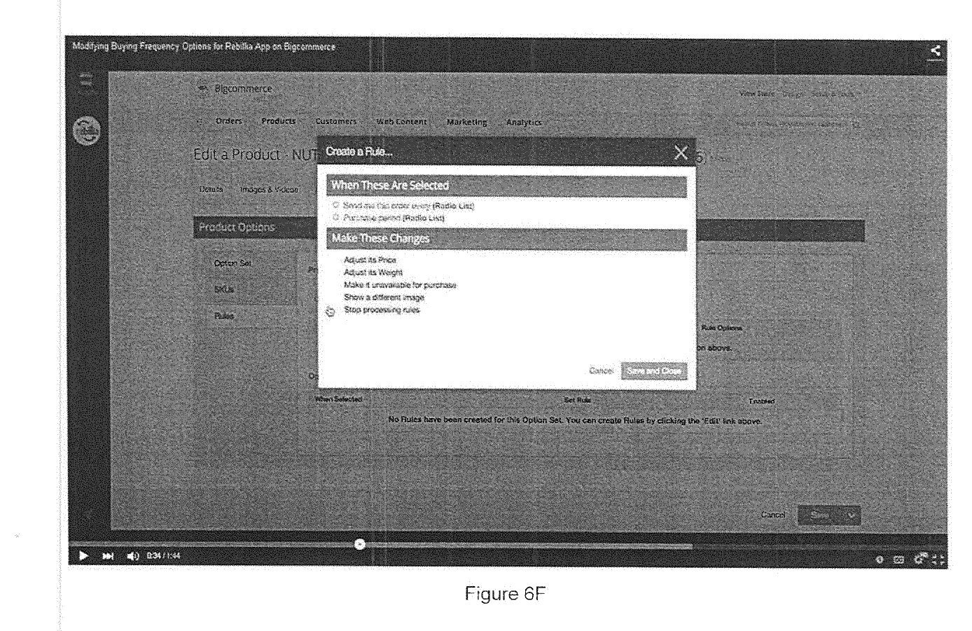

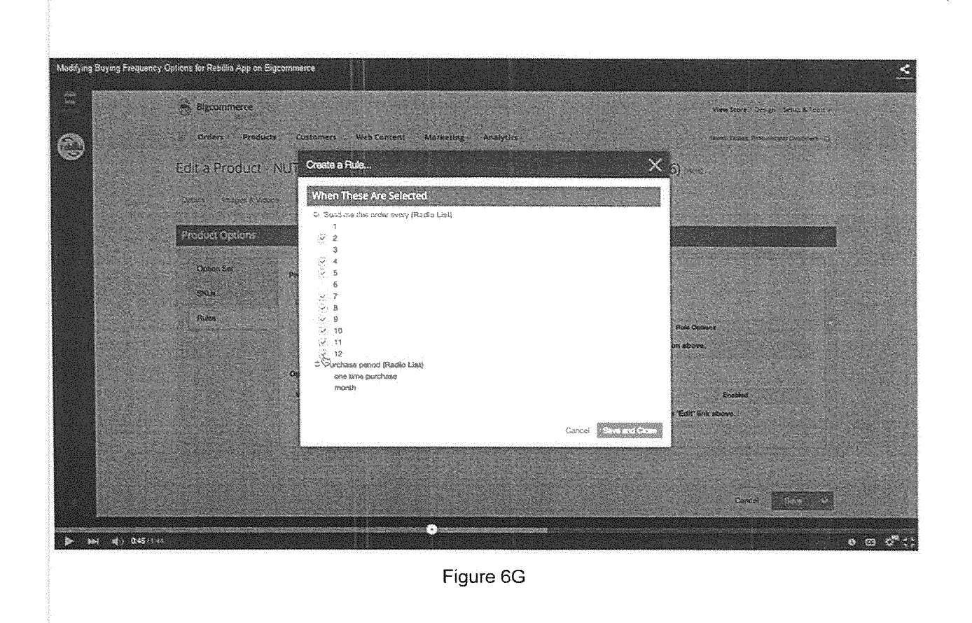

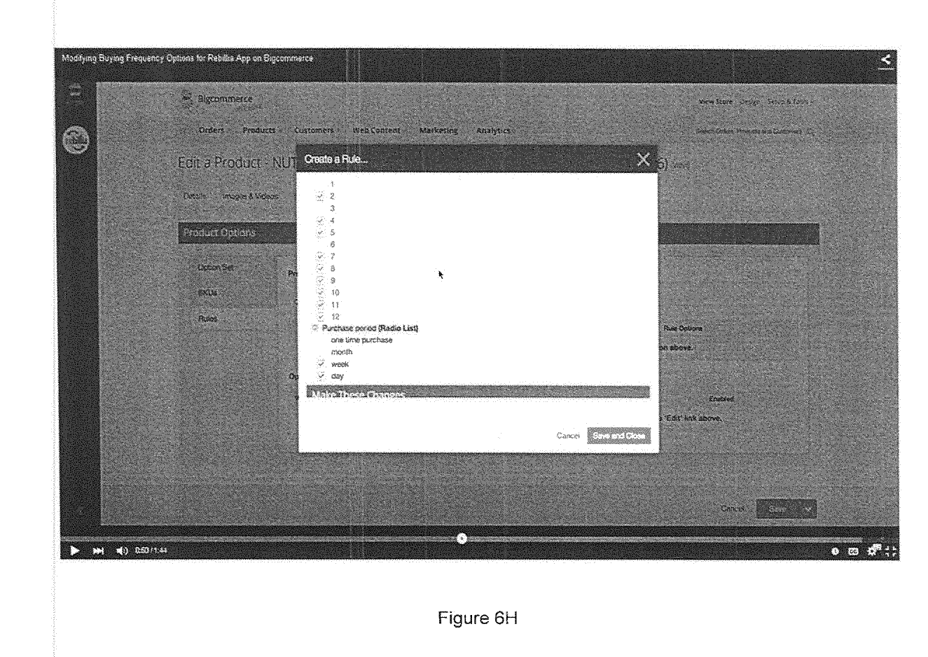

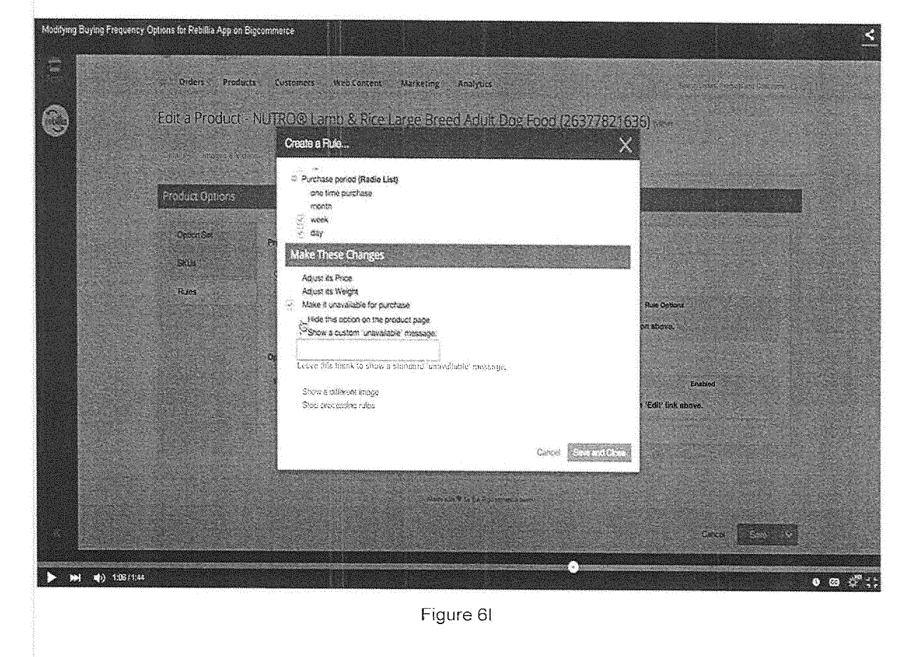

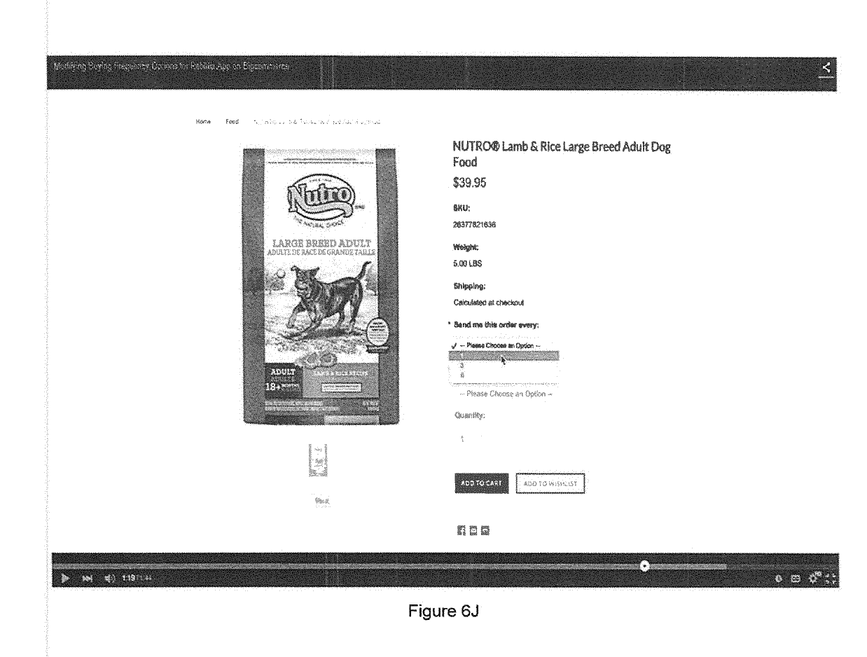

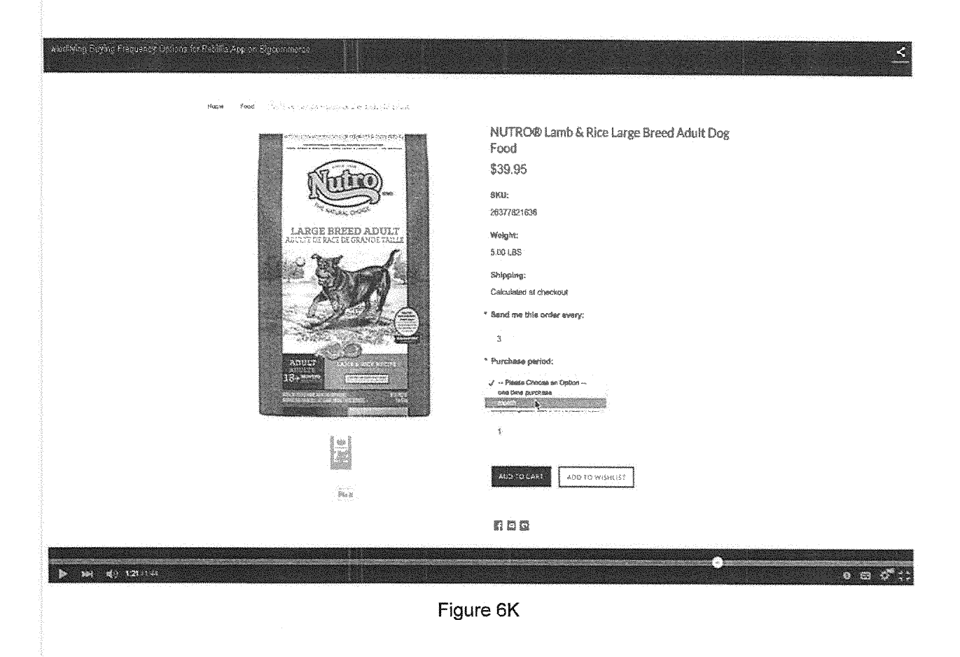

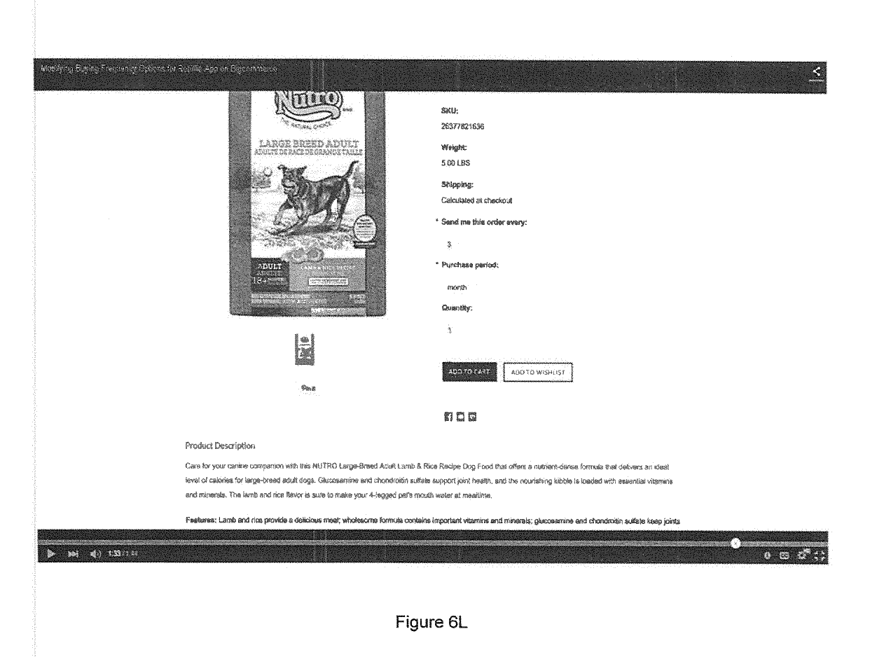

FIGS. 6A-6L illustrate examples of screens which may be used to edit options for a product to include only selected periods for recurring ordering/billing and to present such options to a customer. FIGS. 6A and 6B illustrate screens presented to the customer with options for placing recurring orders for dog food. FIGS. 6C and 6D illustrate screens by which the merchant can select the dog food product to edit its options. FIG. 6E illustrates a screen indicating that the merchant has selected to edit the options for recurring orders. FIG. 6F illustrates a screen presented to the merchant for creating a rule set to indicate what recurring order rules/options will be offered to customers. Using the screen illustrated in FIGS. 6G and 6H, the merchant may select certain recurrence periods, and using the screen shown in FIG. 6I, the merchant user may set a rule to indicate that the dog food will not be available for recurring orders for the periods selected. FIGS. 6J and 6K show updated screens which may be presented to the customer with only the recurring order periods shown that the merchant has elected to make available. And FIG. 6L illustrates a screen reflecting an order placed by the customer for a recurring order period that was made available by the merchant.

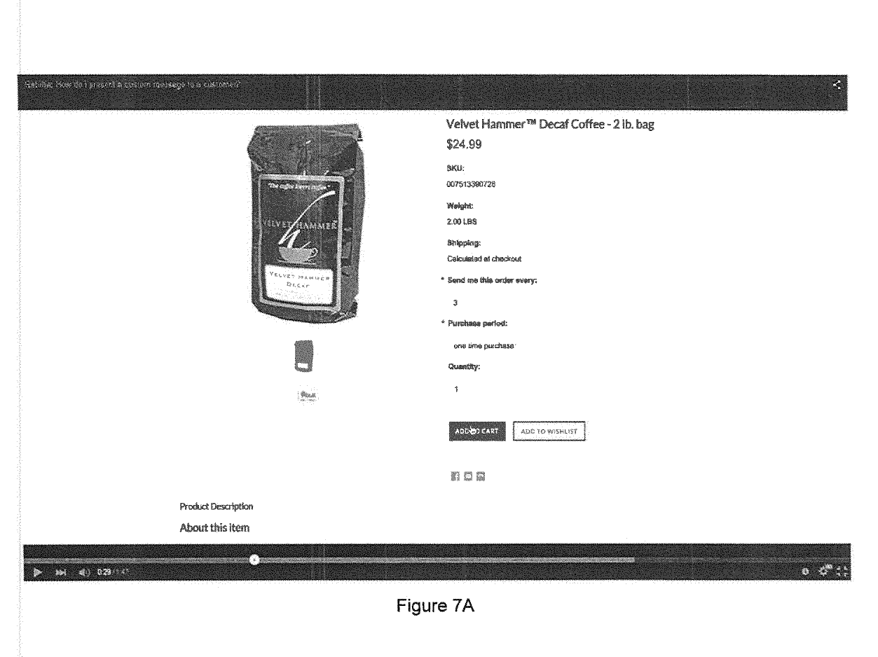

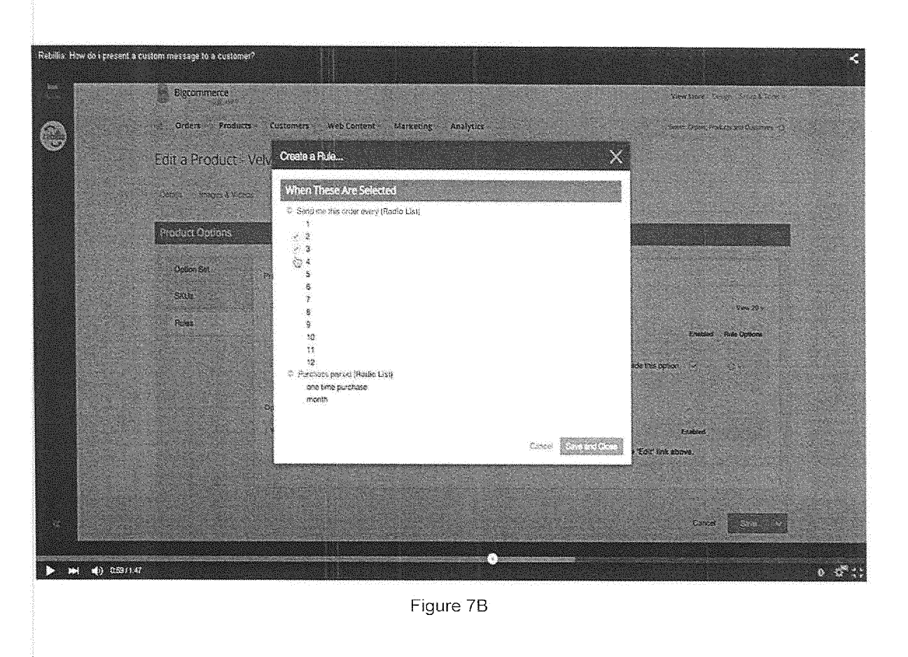

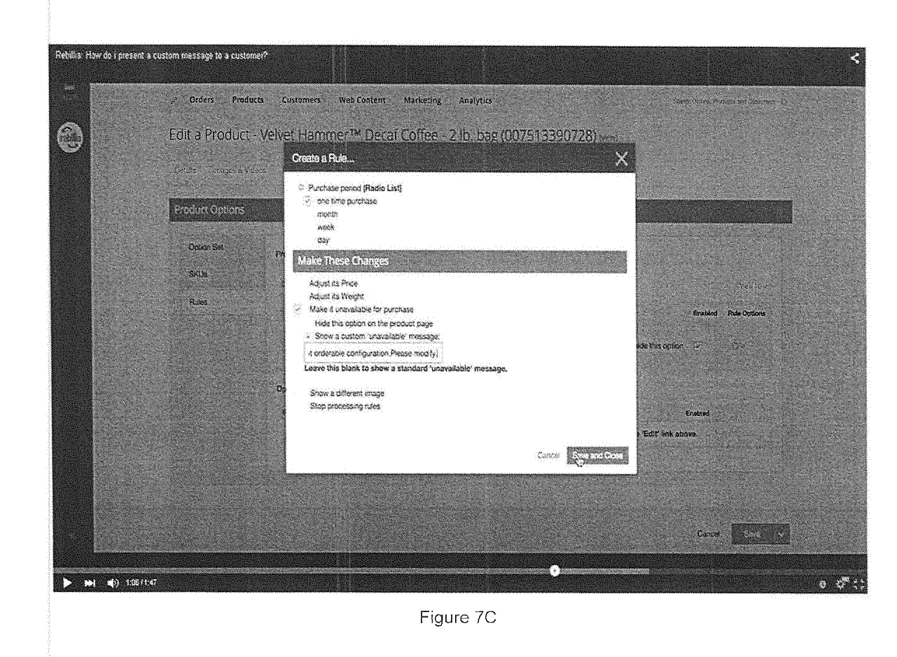

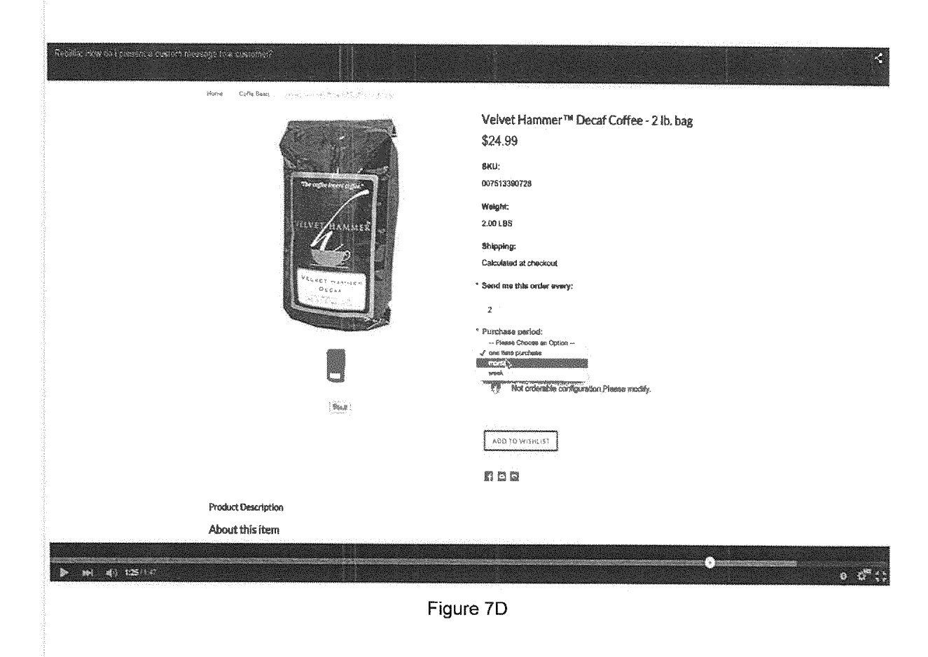

FIGS. 7A-7D illustrate examples of screens which may be used to edit options for a product such that a message is displayed to a customer if a recurring order period is selected which is not a valid recurring order period as set by the merchant. FIG. 7A illustrates a screen indicating that the customer has selected that a recurring order be sent but also indicates that the purchase is a one-time purchase. Absent a message presented to the customer, the customer may not realize that such an order would not to possible to fill. FIG. 7B and 7C illustrate screens which the merchant may use to select periods for recurring orders that will not be made available as options for purchase. FIG. 7C also illustrates an option for entering a message if an invalid reoccurring order is placed by the customer. And FIG. 7D illustrates an updated screen indicating that a recurring order placed for a one-time purchase is not an orderable configuration and asks the customer to modify the order.

The example screens shown and described demonstrate how recurring order options may be enabled and disabled by the merchant as desired via the merchant computer 120 simply by using screens made available by the server 110 (e.g., the ecommerce platform and the recurrence application). Although the examples described above illustrate various intervals and quantities, it should be appreciated that recurring orders may be provided at any desirable frequency/interval (e.g., weeks, days, or months), and any desired number of products may be provided at a selected frequency/interval. These screens can be made available to the appropriate one of the merchant and the customer by the same ecommerce platform that hosts the estore of the merchant, in conjunction with the recurrence application.

In addition to the options described above, other options may be customizable. For example, the merchant may select discounts to be offered to particular customers, e.g., loyalty discounts. The merchant may also select discounts to be offered depending on quantities ordered, the frequencies selected for recurring orders, etc. For example, if a product is ordered in a large quantity and/or at a high recurring frequency (with minimum thresholds predetermined by the merchant), a discount may be provided. The discount may be variable such that the discount offered is greater as the quantity of the order increases or as the frequency of a recurring order increases.

According to example embodiments, using an application provided by the ecommerce server 110, the merchant may manipulate the timing and quantity of products/services made available for ordering by a customer. The merchant can decide which items it wants to allow customers to choose to order on a recurring basis and can also choose the recurring intervals that may be provided as options to customers, without requiring use of an external billing/ordering mechanism. As the merchant selects options and orders are placed, the application keeps track of ordering, billing, and inventory. Thus, the screens mirror what the merchant has in stock, what has been ordered, and what has been billed for.

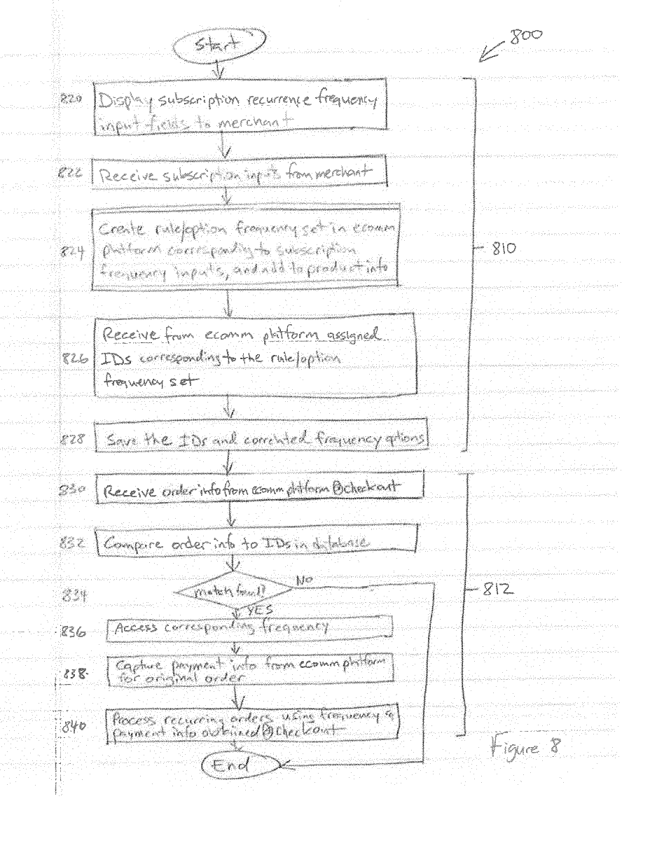

FIGS. 8-19 illustrate aspects of a recurring ordering/billing method, application, computer-readable storage medium, and system according to a second example embodiment. The method includes the process flow as described and claimed herein, which can be implemented in a recurring ordering/billing application, which can be stored on a computer-readable medium. The system can include the same components and configuration as the ecommerce system of the first embodiment.

The features, design, and operation of the essential functionality of the second embodiment is substantially the same as in the first embodiment, and vice versa. So the description of the second embodiment applies to the first embodiment, and vice versa, unless the context and/or description clearly dictates otherwise.

Generally described, the functionality produced by the REBILLIA recurrence application (by working with the ecommerce platform) is as follows. The recurrence application, via the API of the ecommerce platform, creates recurring frequency values (1 month, 2 months, etc.) using the ecommerce platform's rules/options and rules/options sets (e.g., as “Options” of an “Option Set” in the BIGCOMMERCE platform, as “Variants” of an “Option” in the SHOPIFY platform, or as “Rows” of a “Custom Option” in the MAGENTO platform—each platform uses different names for its rules/options and sets/groups thereof). For platforms with libraries (e.g., Options and Option Sets in the BIGCOMMERCE platform), the recurrence application searches for the products that were chosen by the merchant to offer a recurrence frequency set subscription, finds the rule/option set assigned to those products, copies them, adds the recurring option to the rule/option set, and applies the updated rule/option set to the products. Upon completing the rule/option set creation process, the recurrence application receives a response, via the API of the ecommerce platform, with several IDs. The recurrence application collects those ID values (different ID per frequency) and saves them in its database. Then later when a product order is received that includes one of those IDs, the recurrence application uses the database to understand the frequency and the product that needs to be subscribed from within the platform's checkout page (so no redirections or external accounts are needed).

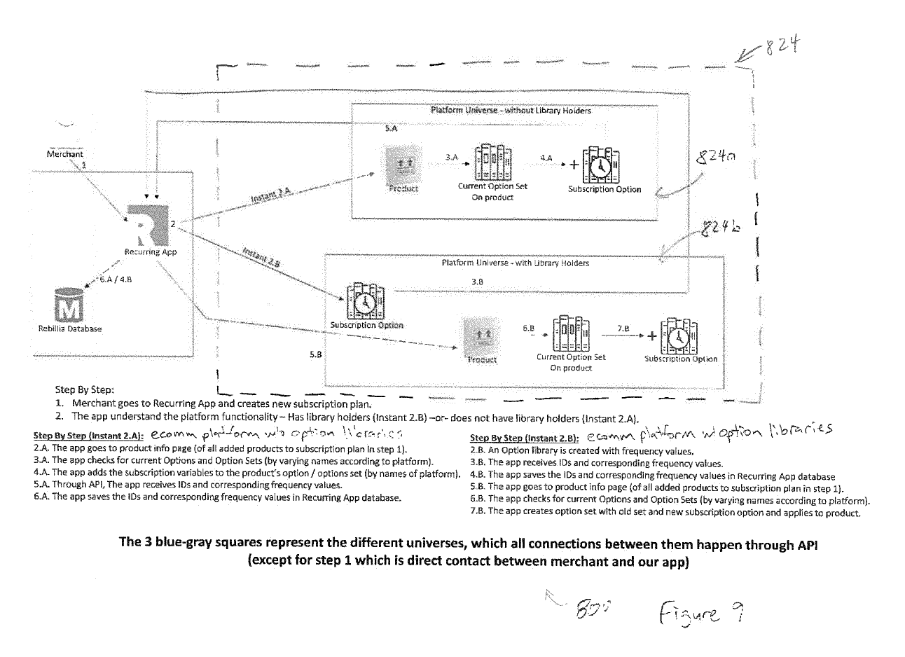

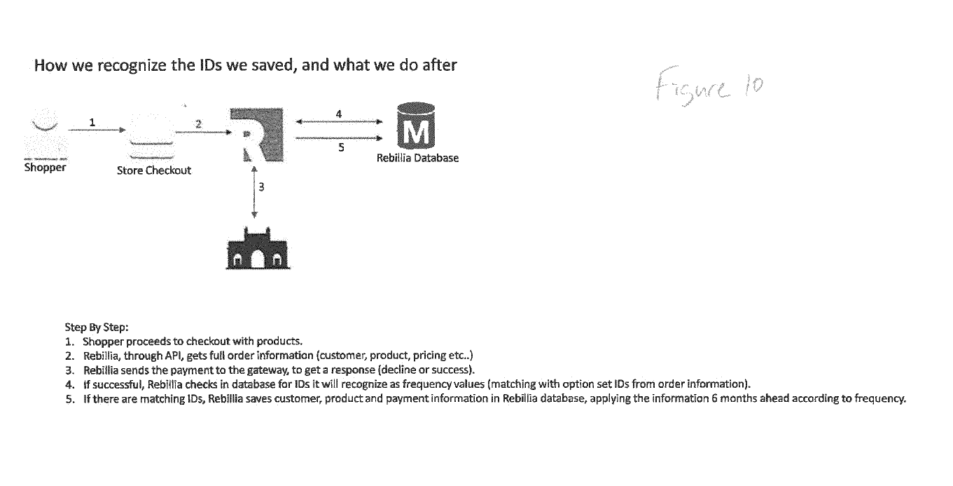

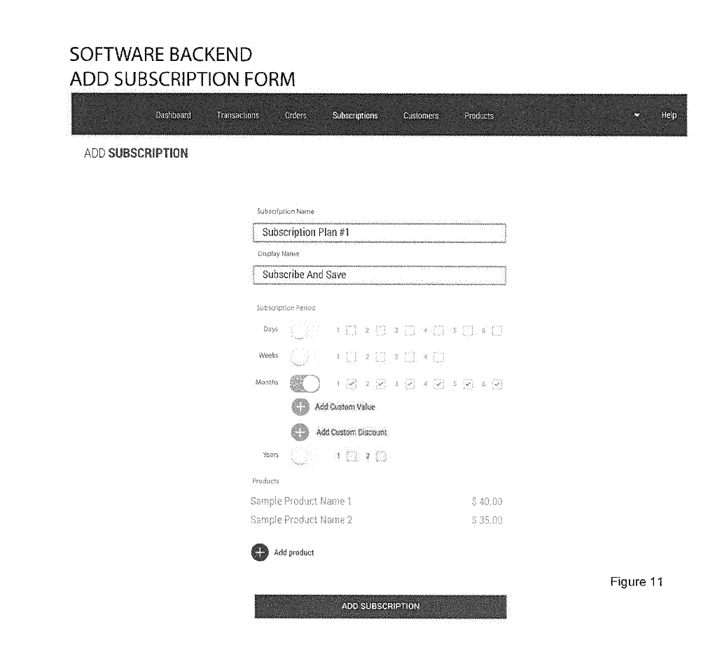

The top-level flow diagram of FIG. 8, in conjunction with the detailed flow diagrams of FIGS. 9-10 and the example screen displays of FIGS. 11-19, explain and illustrate details of this innovative process implemented by the REBILLIA recurrence application in conjunction with the ecommerce platform. These screen shots are representative for illustrating various aspects relating to the second example embodiment, and as such are not intended to be unnecessarily limiting of the invention as claimed herein.

Referring particularly to FIG. 8, there is shown a recurring ordering/billing method 800 according to the second embodiment. As will be described below, this method can be considered to include two parts generally referred to as a recurrence set-up process 810 and a recurring order process 812, which each can be considered to be a discrete aspect of the invention.

The overall recurrence process 800 of the recurrence application is implemented in conjunction with an ecommerce platform such as that described herein that has rules/options for merchants to select rule sets including product options or variants (i.e., product attributes such as size, color, style, or flavor) for products being offered and sold. These rule/option sets are intended to be used by merchants for this purpose (i.e., to define product attribute options such as size, quantity, and color) and are not known to have been previously used for another purpose. In example embodiments, each rule/option set includes a plurality of merchant-selected individual rules/options. As detailed herein, the recurrence process 800 repurposes these rule/option sets in an innovative way to provide advantageous results as described herein including enabling initiating subsequent (after the original order for a product designated as being purchased on a recurring basis) recurring orders without the need for any human intervention and/or need/use of external accounts or billing components.

The recurrence process 800 begins at step 820 by the recurrence application displaying to the merchant computer a screen for creating (in the recurrence application) a recurrence “subscription,” with the screen including functionality (e.g., blank key-in fields, pull-down menus, check boxes, on/off buttons) to input a recurrence name, a recurrence frequency set, and a product name to which that recurrence frequency set is assigned. An example such merchant-facing backend screen display is shown in FIG. 11, in which the merchant has inputted two subscription recurrence names (one for use by the merchant and another for display to customers) and a recurrence frequency set of 1, 2, 3, 4, 5, or 6 months for that name, and assigned two products to that recurrence frequency set (“Sample Product Name 1” and “Sample Product Name 2” are used for illustration purposes to indicate for example “ABC Coffee” and “XYZ Vitamins,” and these products were assigned this frequency set by clicking on the “Add Product” button and selecting them from the presented menu).

Upon the merchant completing entry of the subscription recurrence frequency set and the assigned products, these are received by the recurrence application at step 822. Referring again to the example screen display of FIG. 11, this can be done for instance by the merchant clicking on the “Add Subscription” button.

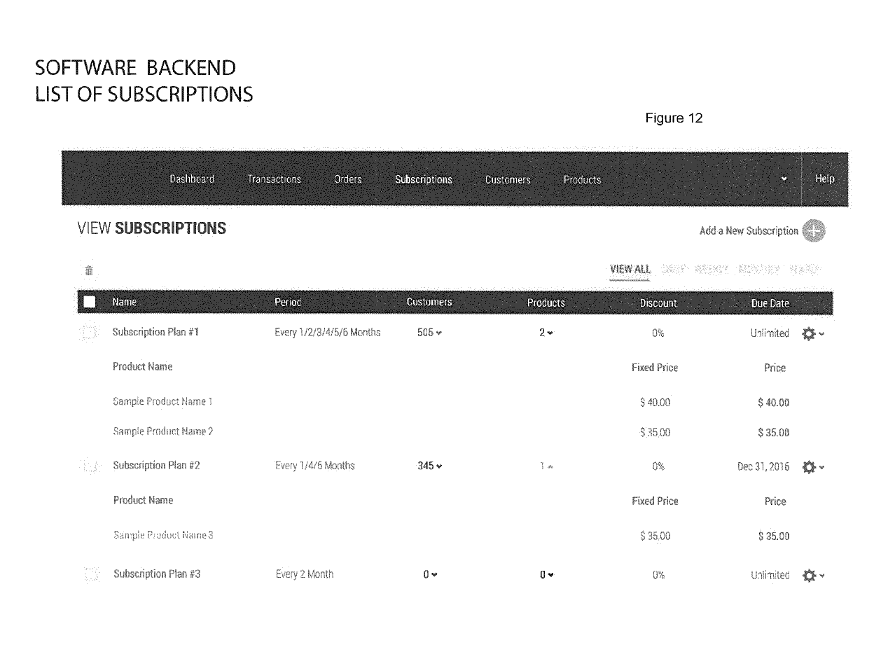

The recurrence application in typical embodiments presents to the merchant computer a screen for viewing and editing the created subscription recurrence frequency sets and their assignments to products. An example such merchant-facing backend screen display is shown in FIG. 12. The merchants can typically also use this screen to add new products to existing subscription recurrence frequency sets.

In response to the recurrence application receiving the subscription inputs, at step 824 it creates a corresponding rule/option set in the ecommerce application for each product assigned that rule/option set. The corresponding rule/option set includes the name and frequency set (or indicia thereof) from the subscription plan inputs. For example, the rule/option set are (or correspond to) the subscription and can be created using the “Create an Option” process in the ecommerce platform, and the rules/options included in the set are (or correspond to) the recurrence frequencies. The recurrence application typically performs this step in response to receiving a new subscription recurrence frequency set (whether the assigned product is existing or also new) or a product information update with a subscription recurrence frequency set (whether the frequency set is new or also updated). Details of two related processes for performing this step will be described below in reference to FIGS. 9 and 14-16.

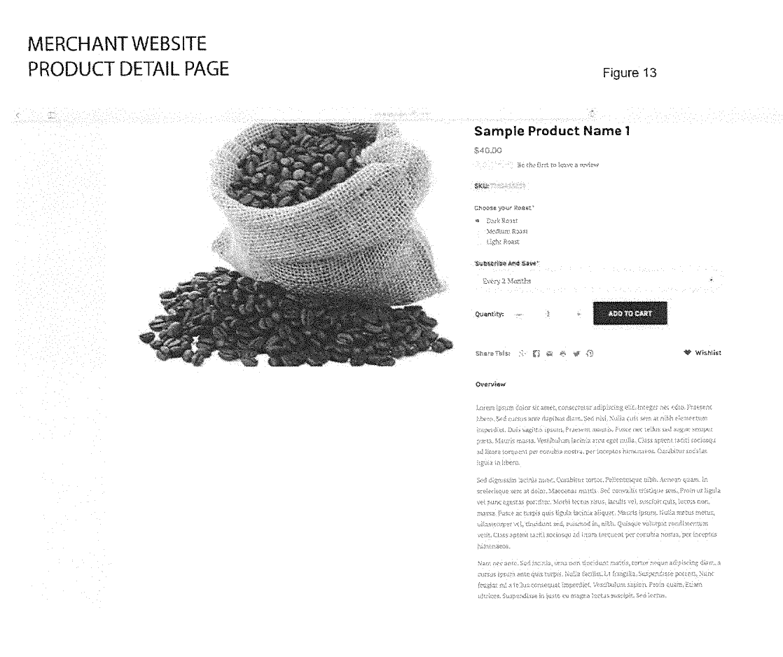

As such, the recurrence application adds the recurrence frequency set to the product information for the assigned products in the ecommerce platform. Now the ecommerce platform includes the recurrence frequency set as part of the product information that it displays on the product webpage of the merchant estorefront to customer computers. An example such customer-facing estorefront screen display is shown in FIG. 13, which follows the example from FIG. 10 and therefore shows the product name (Sample Product Name 1/ABC Coffee), the subscription-plan display name (Subscribe and Save), and a customer-selected frequency (2 months) from the merchant-defined recurrence frequency set (1, 2, 3, 4, 5, or 6 months).

As can be seen in the example screen of FIG. 13, the display for the product also includes another merchant-defined rule/option set created in the ecommerce platform for the dark, medium, or light roast flavors of the coffee product. Thus, it can be seen how the recurrence application enables the merchant to utilize the rules/option set functionality of the ecommerce platform that is designed for product attributes and adapts it for advantageous use related to recurring order frequencies.

At step 826, the recurrence application receives from the ecommerce application a set of IDs assigned by the ecommerce application and correlated to the merchant-defined frequencies of the rule/option set. These IDs are typically received in a response from an API of the ecommerce platform that is prompted by its receipt of the rule/option set creation in the ecommerce app (or by being called for by the recurrence application if it is notified of the rule/option set creation by the ecommerce application).

And at step 828, the recurrence application saves in a database the IDs and the corresponding recurrence frequencies received from the ecommerce platform. The database can be of a conventional type that is accessible by the recurrence application (whether local on the ecommerce server, or whether remote with a connection to the ecommerce server). In this way, the recurrence application knows and has access to the ID for the ecommerce platform that corresponds to each recurrence frequency value, without any human labor or action required.

Before proceeding with the recurring order process 812, details of two related processes for performing step 824 will be described below in reference to FIGS. 9 and 13-15. It will be noted that FIG. 9 generally discloses the overall recurrence set-up process 810, with step 1 of FIG. 9 generally referring to steps 820 and 822 of FIG. 8, and with steps 5A and 6A and steps 3B and 4B of FIG. 9 generally referring to steps 826 and 828 of FIG. 8.

The two related processes 824a and 824b (collectively 824) shown in FIG. 9 are for use with two different types of ecommerce platforms. Process 824a (aka Instant “A”) is for use with an ecommerce platform that does not use option libraries (e.g., the SHOPIFY platform or the MAGENTO platform) and process 824b (aka Instant “B”) is for use with an ecommerce platform that does use option libraries (e.g., the BIGCOMMERCE platform). Common to both processes 824 is that initially the recurrence application looks for option libraries and if it finds none then it proceeds with process 824a and if it finds any then it proceeds with process 824b.

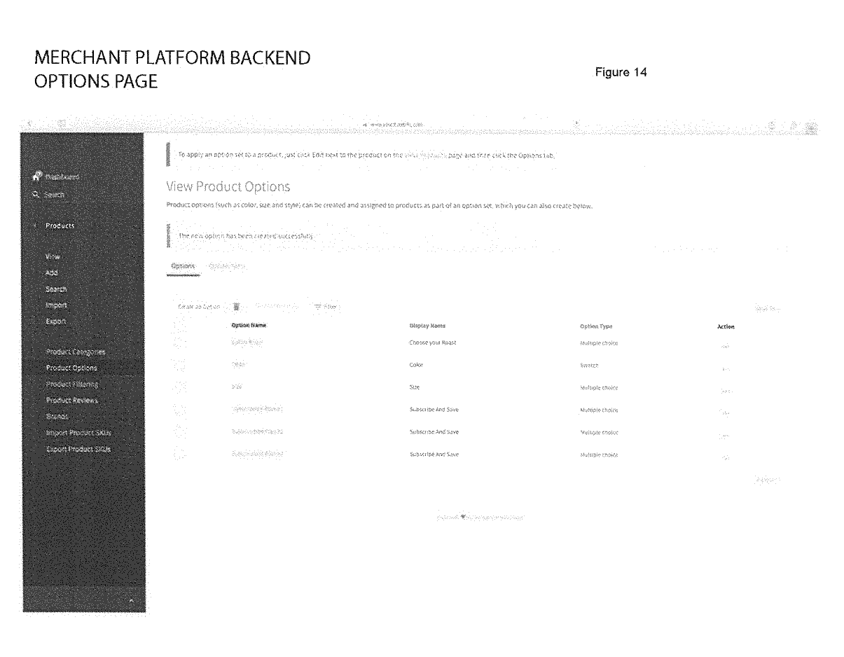

In process 824b (Instant “B”) of FIG. 9, because there are option libraries in the ecommerce platform, the recurrence application creates a rule/option set of recurrence frequencies (the rules/options) in the ecommerce platform (step 2B), so these are the recurrence frequencies and that will be displayed on the storefront for customer to choose from. FIG. 14 shows an example merchant-facing backend screen displaying the recurrence rule/option set frequencies.

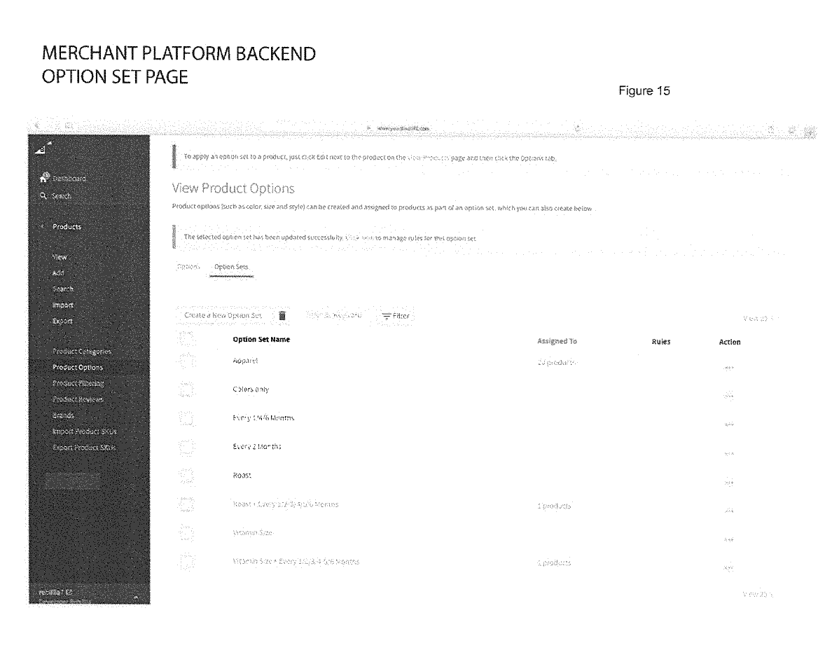

After sending the corresponding IDs to the recurrence application for saving (steps 3B and 4B as detailed elsewhere herein), the recurrence application looks for existing rule/option sets assigned to the products that have been added to the subscription plan of recurrence rule/option set frequencies (steps 5B and 6B). If none are found, then the subscription plan of recurrence rule/option set frequencies is saved for the assigned product. If any existing the existing rule/option sets are found, then it duplicates the existing rule/option sets, adds the rule/option set frequencies to the duplicated existing rule/option sets, and applies the new combination rule/option sets to the product (step 7B). FIG. 15 shows an example merchant-facing backend screen displaying the existing/original and combination rule/option sets. As can be seen in the Figure, the “Roast” rule/option set is the existing/original one, and the “Roast+Every 1/2/3/4/5/6 Months” is the combination rule/option set including the duplicated existing/original rule/option set and the new subscription/frequency rule/option set added to it.

In process 824a (Instant “A”) of FIG. 9, because there are no option libraries in the ecommerce platform, the recurrence application adds the rule/option frequency set directly at the product level. For example, the recurrence application can go to the product info page for the product (step 2A), check for existing rule/option sets (step 3A), and add the created subscription frequency set plan directly to the product information in the ecommerce platform (step 4A). FIG. 16 shows an example merchant-facing backend screen displaying the new/combination rule/option set applied to the product, including the existing/original rule/option set+the automatically, newly, added subscription recurrence rule/option set.

With respect to processes 824a and 824b, it is worth reiterating that the various suitable ecommerce platforms each have their own/different names for the rules/options and sets/groups thereof. The recurrence application as described herein is designed to work with any of these ecommerce platforms without regard to naming conventions used herein or for the platforms. In addition, two different platform functionalities (using libraries of rules/options, and directly without rule/option libraries) are known for setting them up. In typical embodiments, the recurrence application is designed to either apply rules/options to libraries and then to the product, or to apply them directly to the product if there are no libraries, for use with either type of ecommerce platform. In other embodiments, the recurrence application can be designed to work with only one of these types of ecommerce platforms. And persons of ordinary skill in the art will understand that the recurrence application can be readily adapted to work with other ecommerce platforms having different rules/options functionality.

Returning to FIG. 8, details of the recurring order process 812 will now be described. As described above, the recurrence application has access to a database now storing the recurrence frequencies of the subscription rule/options sets and the correlated IDs from the ecommerce platform, as set up by the recurrence set-up process 810.

At some point later in time, a customer will place a recurring order for a product that the merchant has decided to offer on a recurring basis and has assigned a subscription rule/options set of frequencies. FIG. 17 shows an example customer-facing estorefront “Order Confirmation” screen displaying the ordered products and customer-selected options of the merchant-defined available option sets (as step 5 of the check-out process).

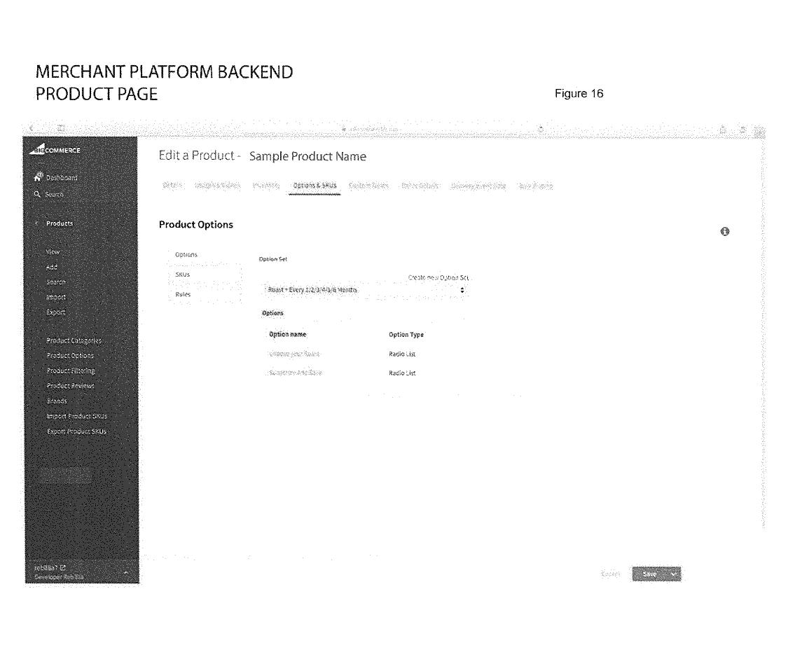

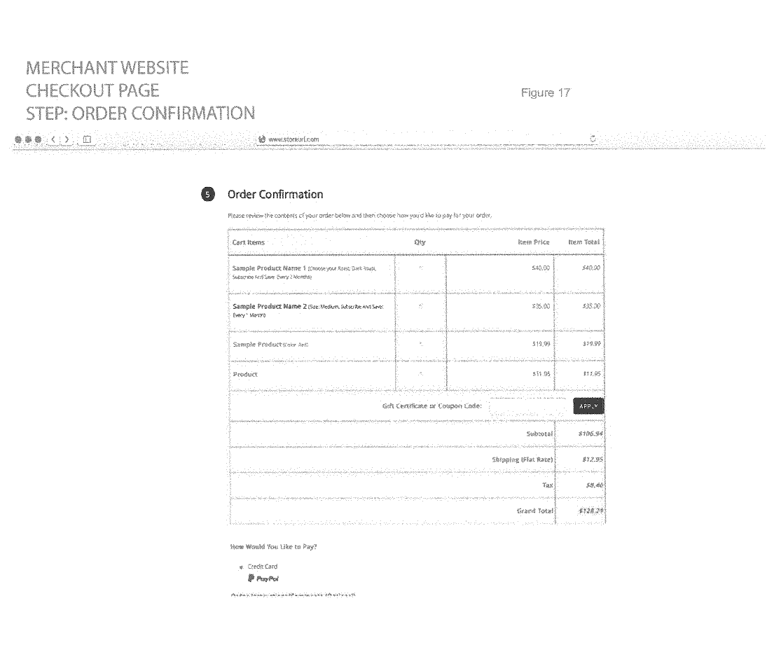

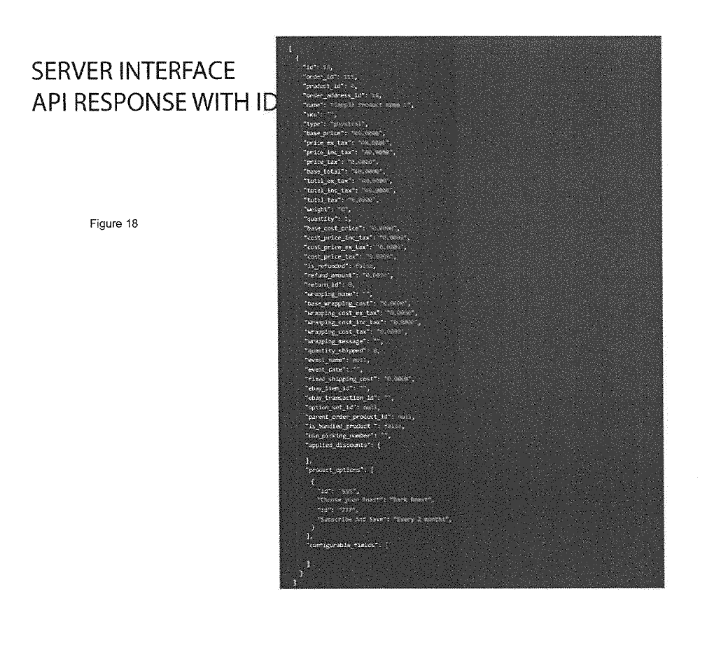

At step 830 the recurrence application receives order information including the product name and option IDs. This order information is typically received from the API of the ecommerce platform in a response that is prompted by its receipt of an order from a customer computer (or by being called for by the recurrence application if it is notified of the order receipt by the ecommerce application). FIG. 18 shows an example server interface API response listing all of the order information including the customer-selected options of the merchant-defined available option sets. In this example screen, the “product options” section (beginning 6 lines from the bottom) lists the rule/option IDs, so the recurrence application looks at the listed “id: 555” and “id: 777,” and by doing a search in the database determines that the former does not correspond to a recurrence frequency (so that ID does not indicate a recurring order) and the latter means “every 2 months” to the recurrence application (indicating a frequency of a recurring order).

At step 832 the recurrence application compares the order information received from the ecommerce platform to the IDs stored in the database. If no match is found at step 834, then the order includes no recurring product purchases, and processing of the one-time purchase continues by the ecommerce platform. But if any matches are found at step 834, then at step 836 the recurrence application accesses the corresponding frequency (to the matched ID) in the database.

For example, the order confirmation screen of FIG. 17 displays “Sample Product Name 1” and for it “Subscribe And Save: Every 2 Months,” which is a rule/option having an ID (not shown in FIG. 18 for convenience) that the recurrence application recognizes as a recurrence frequency. Also displayed for the product is “Roast: Dark,” which is a rule/option having an ID (not shown in FIG. 18) that the recurrence application does not recognize as a recurrence frequency, though this does not affect the recurrence frequency for the ordered product.

FIG. 17 also displays “Sample Product Name 2” and for it “Subscribe And Save: Every 1 Month,” which is a rule/option having an ID (not shown in FIG. 18) that the recurrence application also recognizes as a recurrence frequency. This ID is different than the ID for the “Subscribe And Save: Every 2 Months” rule/option for “Sample Product Name 1,” thus the recurrence frequency will be different.

And this figure also displays “Sample Product” and for it “Color: Red, which is a rule/option having an ID that the recurrence application will not recognize as a recurring frequency in the database. As such, this will be a one-time purchase for this third-listed product. It should be noted that a product can have only a recurrence frequency rule/option, with no other option for it (no purchase choice relating to product attributes such as size, color, flavor, or style) on it and the recurrence application will still work the same for the recurring order.

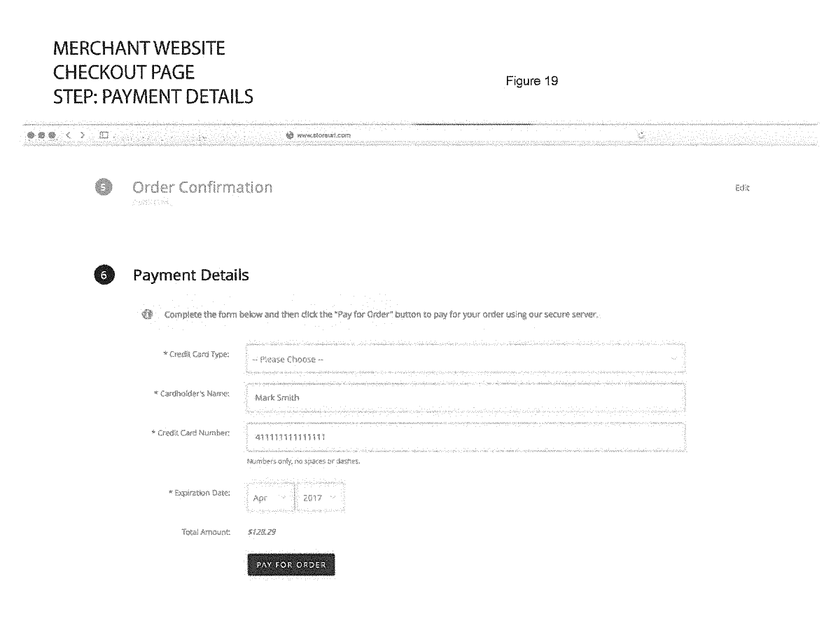

Returning to the recurring ordering process 812 of FIG. 8, the ecommerce application processes the order, including one-time purchases as well as current purchases for which recurring purchases have been requested. Then at step 838 the recurrence application captures payment information, received by the ecommerce platform from the customer computer, for the order (which payment information can be stored in a database for later access and use). FIG. 19 shows an example customer-facing estorefront “Payment Details” screen displaying the payment details for the order (as step 6 of the check-out process). The payment information collected by the recurrence application is the details needed for processing payment of the future recurring orders, typically customer name, contact information, shipping address, billing address, products, product rule/option set, quantity, tax, total price, etc.

Finally, at step 840 the recurrence application initiates the subsequent recurring orders for the products it identified as being ordered on a recurring basis. The recurrence application does this in a timely fashion using the payment information from step 838 and the recurrence frequency from step 836 (and the other relevant product and order information needed for reordering, for example as described with reference to FIG. 17). For example, the recurrence application typically includes a calendaring feature that, when the time comes for the next recurrence of the recurring product order, uses the payment information to enter a charge for the total price for the recurring product order (based on the stored product and order information). The recurrence application sends the charge to a gateway (e.g., of a type conventionally used by ecommerce platforms). If the charge is accepted, then the recurrence application communicates to the ecommerce platform (via the API) to create a new order for the product. Additional example details for processing the recurring orders at step 840 are provided in FIG. 10.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A recurring ordering method, comprising:
receiving from a merchant computer a recurrence subscription set, including a selection of subscription recurrence frequencies, and an assignment of at least one product to the subscription set;
creating a recurrence rule/option set in an ecommerce application for the assigned product, with the recurrence rule/option set including rule/option recurrence frequencies that correspond to the subscription recurrence frequencies of the recurrence subscription set, wherein the rule/option recurrence frequencies are displayed to a customer computer for offering the product on a recurring basis;
receiving from the ecommerce application, and storing, a plurality of recurrence rule/option IDs each corresponding to a respective one of the created rule/option recurrence frequencies;
upon receipt by the ecommerce application of a customer order for the product, receiving order information including ordered rule/option IDs of the customer order;
comparing the ordered rule/option IDs to the stored recurrence rule/option IDs, and for a match to one of the stored recurrence rule/option IDs, identifying the corresponding matched rule/option recurrence frequency; and
initiating with the ecommerce application a recurring order for the product based on the matched rule/option recurrence frequency.

2. The recurring order method of claim 1, wherein the subscription recurrence frequencies of the subscription set define recurring order intervals and the rule/option recurrence frequencies of the recurrence rule/option set define the same recurring order intervals.

3. The recurring order method of claim 2, wherein the recurring order intervals includes days, weeks, months, years, or a combination thereof.

4. The recurring order method of claim 1, wherein the ecommerce application where the recurrence rule/option sets are created enables the merchant computer to set up, in addition to the recurrence rule/option sets, additional rule/option sets for at least one attribute of the product selected from the group consisting of size, color, style, flavor, and a combination thereof.

5. The recurring order method of claim 1, wherein the ecommerce application includes an API from which the created rule/option set IDs and the ordered rule/option recurrence frequency are received.

6. The recurring order method of claim 1, further comprising:
in response to receiving from the ecommerce application a plurality of rule/option IDs, storing the rule/option set IDs and the corresponding rule/set recurrence frequencies in a database; and
in response to receiving the ordered rule/option IDs, accessing the database to search for matching stored rule/option IDs, and for any matches identifying the corresponding rule/option recurrence frequency.

7. The recurring order method of claim 1, wherein the ecommerce application provides for rule/option set libraries, and the step of creating a recurrence rule/option set in an ecommerce application includes determining if any additional rule/option sets exist and if so then including the additional rule/option sets in a combination rule/option set with the recurrence rule/option set.

8. The recurring order method of claim 1, wherein the received order information includes payment information for the customer order, and further comprising the steps of using the payment information to obtain customer payment for the recurring order before initiating the recurring order.

9. The recurring order method of claim 1, wherein in the step of comparing the ordered rule/option IDs to the stored recurrence rule/option IDs, for ordered rule/option IDs not matched to any of the stored recurrence rule/option IDs, the product is determined to be purchased on a one-time basis.

10. A non-transitory computer-readable medium storing computer-executable instructions for performing the method of claim 1.

11. A ecommerce server including the non-transitory computer-readable medium of claim 10.

12. A recurring ordering method, comprising:
receiving from a merchant computer a recurrence subscription set, including a selection of subscription recurrence frequencies, and an assignment of at least one product to the subscription set;
creating a recurrence rule/option set in an ecommerce application for the assigned product, with the recurrence rule/option set including rule/option recurrence frequencies that correspond to the subscription recurrence frequencies of the recurrence subscription set, wherein the rule/option recurrence frequencies are displayed to a customer computer for offering the product on a recurring basis;
receiving from the ecommerce application, and storing, a plurality of recurrence rule/option IDs each corresponding to a respective one of the created rule/option recurrence frequencies;
upon receipt by the ecommerce application of a customer order for the product, receiving order information from the ecommerce application including ordered rule/option IDs and payment information of the customer order;
comparing the ordered rule/option IDs to the stored recurrence rule/option IDs, and for a match to one of the stored recurrence rule/option IDs, identifying the corresponding matched rule/option recurrence frequency; and
initiating with the ecommerce application a recurring order for the product based on the matched rule/option recurrence frequency and the payment information, without accessing an external account or mechanism to obtain the rule/option recurrence frequency or the payment information,
wherein the ecommerce application where the recurrence rule/option sets are created enables the merchant computer to set up, in addition to the recurrence rule/option sets, additional rule/option sets for at least one attribute of the product selected from the group consisting of size, color, style, flavor, and a combination thereof.

13. The recurring order method of claim 12, wherein the subscription recurrence frequencies of the subscription set define recurring order intervals and the rule/option recurrence frequencies of the recurrence rule/option set define the same recurring order intervals, wherein the recurring order intervals includes days, weeks, months, years, or a combination thereof.

14. The recurring order method of claim 12, wherein the ecommerce application includes an API from which the created rule/option set IDs and the ordered rule/option recurrence frequency are received.

15. The recurring order method of claim 12, further comprising:
in response to receiving from the ecommerce application a plurality of rule/option IDs, storing the rule/option set IDs and the corresponding rule/set recurrence frequencies in a database; and
in response to receiving the ordered rule/option IDs, accessing the database to search for matching stored rule/option IDs, and for any matches identifying the corresponding rule/option recurrence frequency.

16. The recurring order method of claim 12, wherein the ecommerce application provides for rule/option set libraries, and the step of creating a recurrence rule/option set in an ecommerce application includes determining if any additional rule/option sets exist and if so then including the additional rule/option sets in a combination rule/option set with the recurrence rule/option set.

17. The recurring order method of claim 12, wherein in the step of comparing the ordered rule/option IDs to the stored recurrence rule/option IDs, for ordered rule/option IDs not matched to any of the stored recurrence rule/option IDs, the product is determined to be purchased on a one-time basis.

18. A non-transitory computer-readable medium storing computer-executable instructions for performing the method of claim 12.

19. A ecommerce server including the non-transitory computer-readable medium of claim 18.

20. A recurring ordering method for use with an ecommerce application providing a feature for a connected merchant computer to create rule/option sets for at least one attribute of a product selected from the group consisting of size, color, style, flavor, and a combination thereof, the method comprising:
using the rule/option set feature to set up a recurrence rule/option set including recurrence frequencies;
assigning the recurrence rule/option set to the product;
identifying rule/set IDs assigned by the ecommerce application to the recurrence frequencies;
upon a customer order being received by the ecommerce application, comparing order rule/set IDs in the customer order to the identified rule/set IDs and for a match identifying the corresponding recurrence frequency; and
initiating with the ecommerce application a recurring order for the product based on the matched recurrence frequency.
